(19) United States
(12) Patent Application Publication
(10) Pub. No.: US 2026/0166432 A1
(43) Pub. Date: Jun. 18, 2026

(54) ONE OR MORE COMPUTER-READABLE STORAGE MEDIA, GAME SYSTEM, AND GAME PROCESSING METHOD

(71) Applicant: NINTENDO CO., LTD., Kyoto (JP)

(72) Inventor: Yusuke KITAZONO, Kyoto (JP)

(21) Appl. No.: 19/405,868

(22) Filed: Dec. 2, 2025

(30) Foreign Application Priority Data
Dec. 13, 2024 (JP) 2024-218777

(51) Int. Cl. A63F 13/56; A63F 13/49; A63F 13/79; G06T 17/20

(52) U.S. Cl. CPC A63F 13/56; A63F 13/49; A63F 13/79; G06T 17/205

(57) ABSTRACT

In a first case in which a player character is on at least a terrain that is a voxel object, movement control of the player character is performed at a position on the terrain based on an operation input, and the position of the player character is stored as a history. When a first condition is satisfied due to movement of the player character, the movement control based on the operation input is interrupted, a return position is determined from candidates including a plurality of positions included in the history, except for a position where the terrain is not present, and the player character is caused to move and return to the return position, and the movement control based on the operation input is resumed.

### CROSS REFERENCE TO RELATED APPLICATION

This application claims priority to Japanese Patent Application No. 2024-218777, filed on Dec. 13, 2024, the entire contents of which are incorporated herein by reference.

### FIELD

The technology disclosed herein relates to one or more computer-readable storage media, game systems, and game processing methods that generate an object in a virtual space using voxel data.

### BACKGROUND AND SUMMARY

In the case in which a game employing the voxel mesh generation technique is provided, it is considered that a position to which a player character is caused to return cannot be appropriately set, if in the game a mesh is likely to be deformed.

A technique for generating a mesh based on voxel data has conventionally been proposed.

The present example discloses one or more computer-readable storage media, a game system, and a game processing method in which a position to which a player character is caused to return can be appropriately set.

The present example may have the following features (1) to (10), for example.

(1) An example configuration of one or more non-transitory computer-readable storage media according to the present example is one or more non-transitory computer-readable storage media having stored therein instructions that, when executed, cause an information processing system to perform operations comprising: updating voxel data defined in a virtual space and indicating a terrain, based on game processing, wherein in the voxel data, for each of a plurality of voxels, at least a density indicating the degree of virtual occupation of a content in a space defined by the voxel is set; updating a terrain mesh related to the voxel data and indicating the terrain, wherein vertex coordinates of the terrain mesh are determined based on at least the density included in the voxel data; and in the game processing, in a first case in which a player character is on at least the terrain, performing movement control of the player character at a position on the terrain based on an operation input, and storing the position of the player character as a history, and when a first condition is satisfied due to movement of the player character, interrupting the movement control based on the operation input, determining a return position from candidates including a plurality of positions included in the history, except for a position where the terrain is not present, and causing the player character to move and return to the return position, and resuming the movement control based on the operation input.

With the configuration of (1), the return position of a player character can be appropriately set so as to prevent the player character to return to a position where a terrain is no longer present in a game in which a generated terrain mesh is likely to be deformed based on updating of voxels.

(2) In the configuration of (1), the operations may further comprise, in the game processing: causing the player character to perform a first action based on an operation input; setting a first voxel update range in the virtual space based on the first action; and reducing the densities of voxels of the voxel data related to the first voxel update range.

With the configuration of (2), even when a terrain is deformed by a player character's action, the return position of the player character can be appropriately set.

(3) In the configuration of (1) or (2), the operations may further comprise, in the game processing: in a second case in which the player character is in contact with the terrain in at least a forward direction, controlling the player character so as to allow the player character to move at a position where the player character is in contact with the terrain, based on an operation input, and storing the position of the player character as the history.

With the configuration of (3), even when a player character moves on a wall surface, the return position of the player character can be appropriately set.

(4) In the configuration of (3), the operations may further comprise: in the second case, storing a position where the player character is located each time the player character moves over a distance, and a position where the player character stops, as at least the history.

With the configuration of (4), even on a wall surface where a player character has moved, an appropriate position can be stored as a history.

(5) In the configuration of any one of (1) to (4), the operations may further comprise, in the game processing: when the player character reaches a checkpoint in the virtual space, storing the checkpoint as the candidate, and removing the history previously stored from the candidates.

With the configuration of (5), when a player character reaches a particular checkpoint, the player character can be prevented from returning to a position previously stored.

(6) In the configuration of any one of (1) to (5), the operations may further comprise, in the game processing: determining a most recent one of the candidates as the return position.

With the configuration of (6), a player character can be caused to return to a most recent position in the history.

(7) In the configuration of any one of (1) to (6), the first condition may include a condition that the position of the player character is in a first range in the virtual space.

With the configuration of (7), when a player character enters the first range, the player character can be caused to return to a return position.

(8) In the configuration of any one of (1) to (7), the first condition may further include a condition that a first possessed item that is consumed due to the return movement of the player character remains.

With the configuration of (8), the effect of causing a player character to return to a return position and allowing the movement control can be imparted to the first possessed item.

(9) In the configuration of any one of (1) to (8), in the voxel data, a material indicating the type of the content may be set for each of the plurality of voxels. The operations may further comprise: generating or updating a display mesh related to the voxel data and to be rendered based on a virtual camera, by determining vertex coordinates of the display mesh based on at least the density included in the voxel data and determining a material of the display mesh based on at least the material included in the voxel data; and rendering the virtual space including the display mesh based on the vertex coordinates of the display mesh and a texture related to the material of the display mesh.

With the configuration of (9), a determination mesh and a display mesh are determined separately, and therefore, an appropriate mesh can be used for each application.

(10) In the configuration of any one of (1) to (8), in the voxel data, a material indicating the type of the content may be set for each of the plurality of voxels. The operations may further comprise: determining a material of the terrain mesh based on at least the material included in the voxel data; and rendering the virtual space including the terrain mesh as a display mesh based on vertex coordinates of the display mesh and a texture related to the material of the display mesh.

With the configuration of (10), the rendering and the collision determination can be performed using the same mesh, resulting in a reduction in processing load for setting meshes.

Furthermore, the present example may be carried out in forms of a game system and a game processing method.

According to the present example, a return position of a player character can be appropriately set in a game in which a generated mesh is likely to be deformed based on updating of voxels.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a view showing a non-limiting example where a left controller and a right controller are attached to a main body apparatus;

FIG. 2 is a view showing a non-limiting example where a left controller and a right controller are removed from a main body apparatus;

FIG. 3 is a six-sided view showing a non-limiting example of a main body apparatus;

FIG. 4 is a six-sided view showing a non-limiting example of a left controller;

FIG. 5 is a six-sided view showing a non-limiting example of a right controller;

FIG. 6 is a block diagram showing a non-limiting example of an internal configuration of a main body apparatus;

FIG. 7 is a block diagram showing a non-limiting example of an internal configuration of a main body apparatus, a left controller and a right controller;

FIG. 8 is a view showing a non-limiting example of a terrain object, which is a voxel object;

FIG. 9 is a view showing a non-limiting example of a state before and after the deletion of a portion of the terrain object shown in FIG. 8;

FIG. 10 is a view showing a non-limiting example of states before and after the deletion of a portion of the terrain object shown in FIG. 8;

FIG. 11 is a view showing a non-limiting example of voxel data;

FIG. 12 is a view showing a non-limiting example of material data;

FIG. 13 is a view showing a non-limiting example of a game space when an update event has occurred;

FIG. 14 is a view showing a non-limiting example of an update range;

FIG. 15 is a view showing a non-limiting example of a method for setting vertices;

FIG. 16 is a view showing a non-limiting example of a method for determining a material of a vertex;

FIG. 17 is a view showing a non-limiting example of vertex simplification;

FIG. 18 is a view showing a non-limiting example of conditions regarding materials;

FIG. 19 is a view showing a non-limiting example of a mesh generated based on vertices;

FIG. 20 is a view showing a non-limiting example of division of a quadrangle forming a mesh into two triangles;

FIG. 21 is a view showing a non-limiting example of a method for determining materials of polygons forming a display mesh;

FIG. 22 is a view showing a non-limiting example of materials set for vertices of adjacent two polygons;

FIG. 23 is a view showing a non-limiting example of application of textures to polygons;

FIG. 24 is a view showing a non-limiting example of a method for determining materials of polygons forming a determination mesh;

FIG. 25 is a diagram showing a non-limiting example of a game image representing a series of states in which a player character 201 moving on a terrain object enters an entrance-forbidden area in a game space, and thereafter, returns to a return position using a return item;

FIG. 26 is a diagram showing a non-limiting example of a game image representing a series of states in which a player character 201 moving on a terrain object enters an entrance-forbidden area in a game space, and thereafter, returns to a return position using a return item;

FIG. 27 is a diagram showing a non-limiting example of a game image representing a series of states in which a player character 201 moving on a terrain object enters an entrance-forbidden area in a game space, and thereafter, returns to a return position using a return item;

FIG. 28 is a diagram showing a non-limiting example of a history of positions related to movement is stored when a player character 201 is on a terrain in a game space;

FIG. 29 is a diagram showing a non-limiting example of a history of positions related to movement is stored when a player character 201 is moving along a wall surface in a game space;

FIG. 30 is a diagram showing a non-limiting example in which a candidate position is set based on a motion that a player character 201 performs to use a save point;

FIG. 31 is a diagram showing a non-limiting example in which a plurality of recorded candidate positions are described in order of priority level with the highest first;

FIG. 32 is a diagram showing a non-limiting example of a mini-game stage in which a player character 201 moves a single path from which the player character 201 enters an entrance-forbidden area if the player character 201 falls therefrom;

FIG. 33 is a view showing a non-limiting example of various data used for information processing in a game system;

FIG. 34 is a flowchart showing a non-limiting example of a flow of game processing executed by a game system;

FIG. 35 is a subroutine showing a non-limiting example of a process of controlling a motion of each object in step S12 of FIG. 34;

FIG. 36 is a subroutine showing a non-limiting example of a first half of a candidate position setting process in step S46 of FIG. 35;

FIG. 37 is a subroutine showing a non-limiting example of a second half of the candidate position setting process in step S46 of FIG. 35; and

FIG. 38 is a subroutine showing a non-limiting example of a return position movement process in step S47 of FIG. 35.

### DETAILED DESCRIPTION OF NON-LIMITING EXAMPLE EMBODIMENTS

### [1. Configuration of Game System]

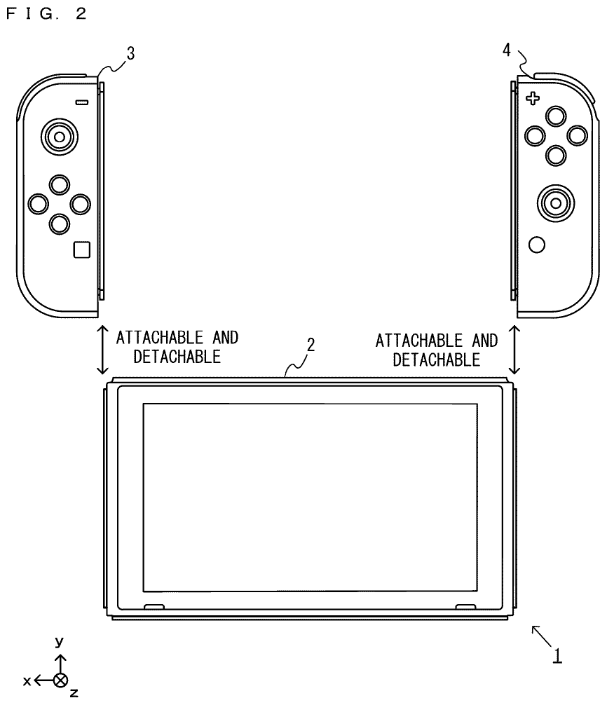

A game system according to the present example is described below. An example of a game system 1 according to the present example includes a main body apparatus (an information processing apparatus; which functions as a game apparatus main body in the present example) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the present example is described, and then, the control of the game system 1 according to the present example is described.

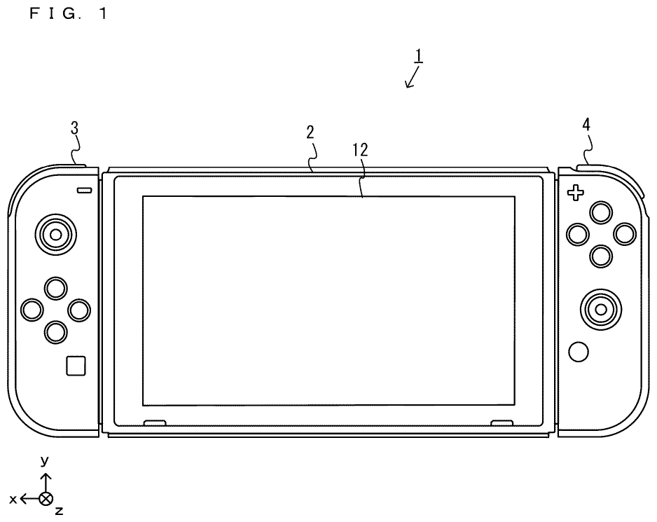

FIG. 1 is a diagram showing an example of the state in which the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state in which each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

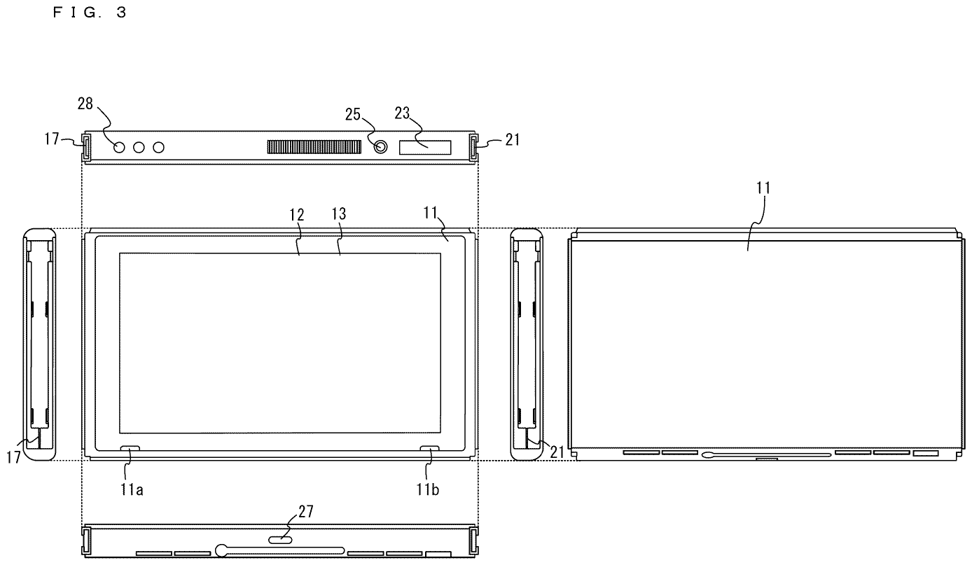

FIG. 3 is six orthogonal views showing an example of the main body apparatus 2. As shown in FIG. 3, the main body apparatus 2 includes an approximately plate-shaped housing 11. In the present example, a main surface (e.g., a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any type.

Further, the main body apparatus 2 includes a touch panel 13 on a screen of the display 12. In the present example, the touch panel 13 is of a type that allows a multi-touch input (e.g., a capacitive type). The touch panel 13, however, may be of any type. For example, the touch panel 13 may be of a type that allows a single-touch input (e.g., a resistive type).

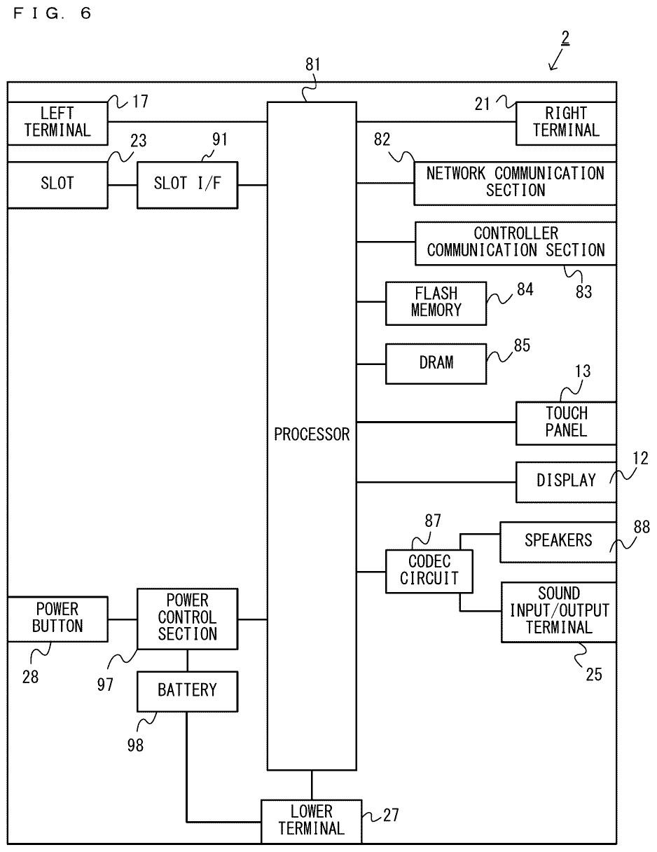

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the present example, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the present example, the cradle has the function of charging the unified apparatus or the main body apparatus 2 alone mounted on the cradle. Further, the cradle has the function of a hub device (specifically, a USB hub).

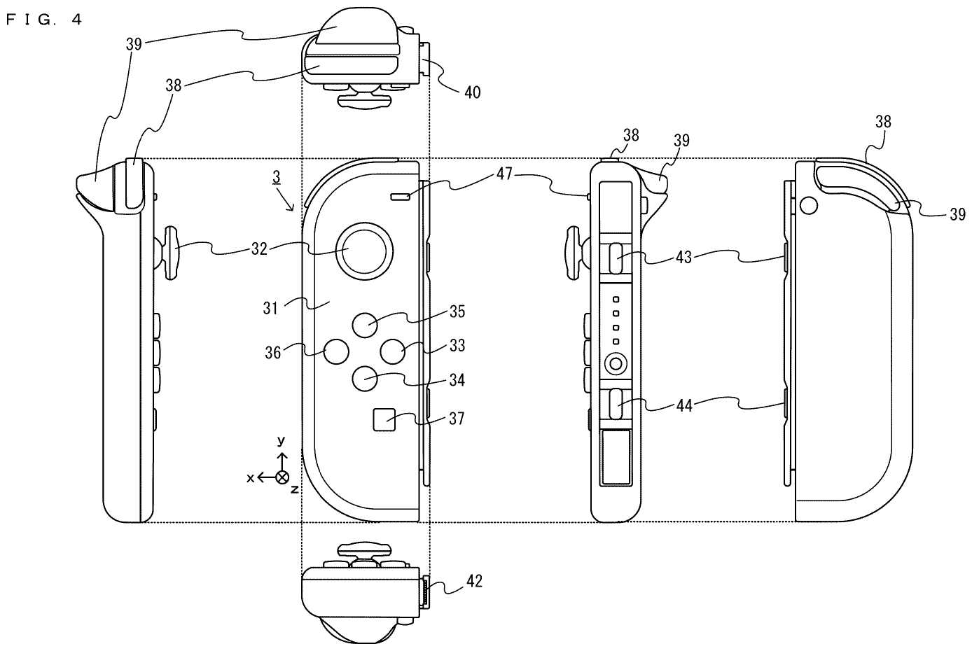

FIG. 4 is six orthogonal views showing an example of the left controller 3. As shown in FIG. 4, the left controller 3 includes a housing 31. In the present example, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

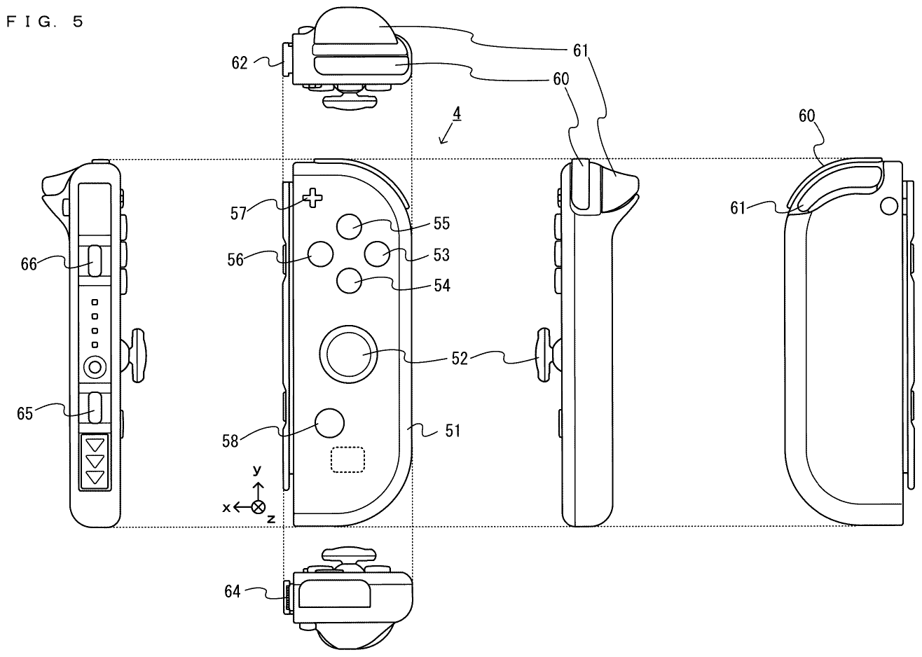

FIG. 5 is six orthogonal views showing an example of the right controller 4. As shown in FIG. 5, the right controller 4 includes a housing 51. In the present example, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the present example, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the present example, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

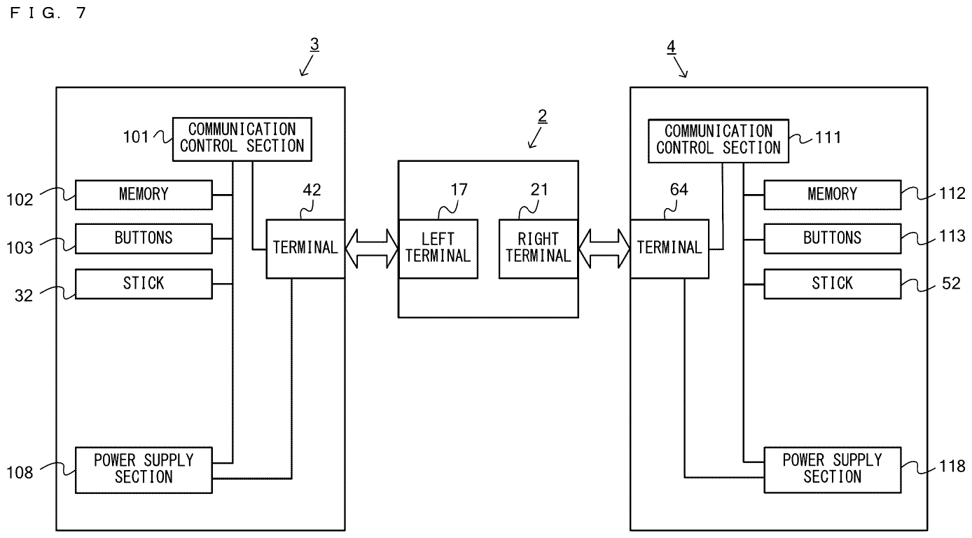

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the present example, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Outline of Process on Game System]

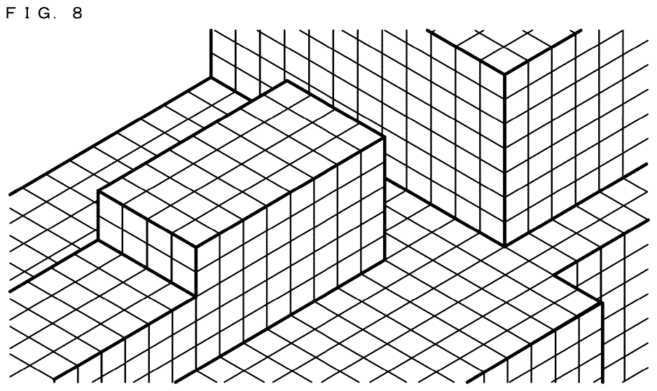

Next, referring to FIGS. 8 to 38, an outline of the process performed on the game system 1 will be described. In the present example, the game system 1 generates a game image in which terrain objects and characters (e.g., the player character controlled by the player) are arranged in a game space, which is a three-dimensional virtual space, and displays the game image on a display device. Note that in the present example, the display device on which the game image is displayed may be the display 12 described above, or may be a stationary monitor.

### [2-1. Voxel]

In the present example, for some objects in the game space, the shape is defined by voxel data. Here, voxels are rectangular parallelepiped (more specifically, cubic) regions arranged in a grid pattern in the game space, and voxel data is data indicating information regarding the voxels. Hereinafter, an object whose shape is defined by voxel data will be referred to as a “voxel object”. In the present example, the game system 1 stores voxel data for a plurality of voxels that are set in the game space as data for generating voxel objects in the game space.

FIG. 8 is a view showing an example of a terrain object, which is a voxel object. As shown in FIG. 8, in the present example, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

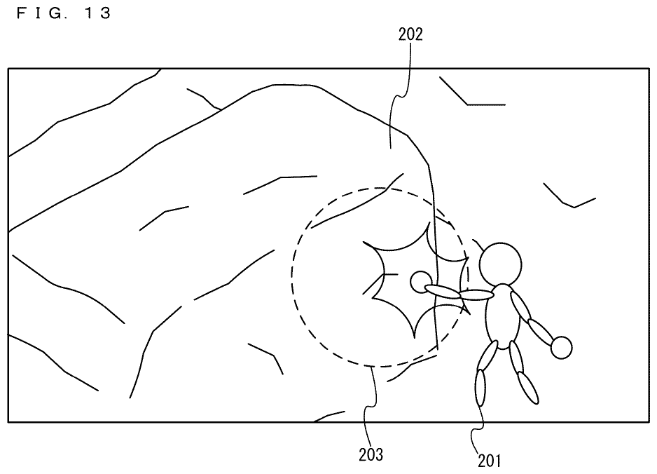

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the present example, in practice, a voxel object is generated (e.g., based on voxel data) by such a rule that results in a terrain object having a complicated shape, such as a terrain object shown in FIG. 13 to be described below, for example. Note that there is no limitation on the rule for determining the shape of the voxel object based on the voxel data. In other examples, the game system 1 may generate a voxel object as shown in FIG. 8 based on the object data or may generate a voxel object as shown in FIG. 13 based on the object data.

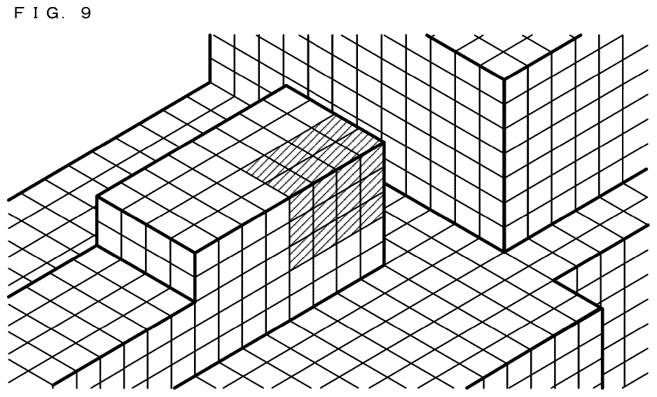

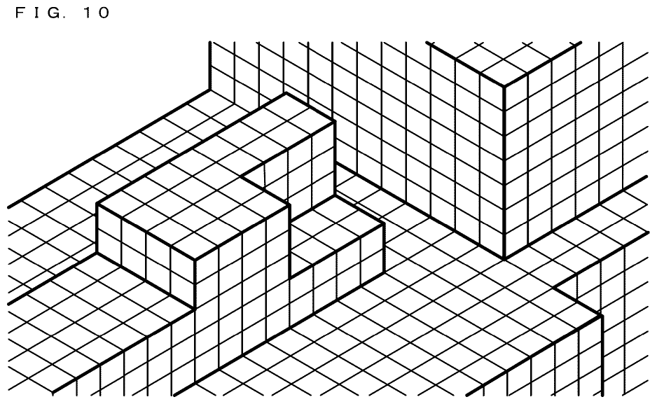

It is possible to change the shape of a voxel object by changing voxel data of voxels FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

In the present example, voxels are defined in the entire game space (e.g., a voxel space in which voxels are set corresponds to the entire game space). However, the voxel space may not necessarily be set over the entire game space, and may be set in a certain area in the game space. If the voxel space is set in a certain area in the game space, the shape of the voxel object is defined by voxel data regarding voxels in the voxel space, and the position of the voxel object in the game space is defined by the position of the voxel space in the game space. The game space may include a main voxel space that is set over the entire game space, and a sub voxel space that is set in a certain area in the game space. In this case, the game system 1 stores therein the voxel data for each voxel space.

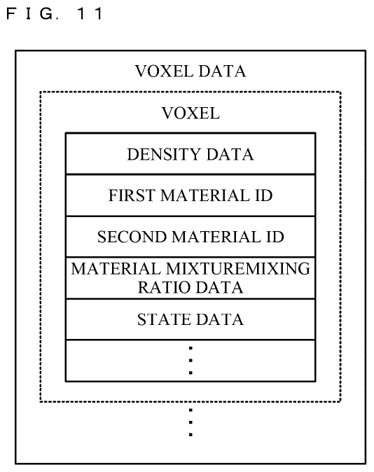

FIG. 11 shows an example of voxel data. The voxel data includes density data, a first material ID, a second material ID, material mixing ratio data, and state data, for each voxel defined in the game space. In the voxel data according to the present example, these pieces of data are set for each voxel.

The density data indicates a density that is an index used for defining the shape of a voxel object based on the voxel (specifically, the shape defined by a mesh described below). As will be described in detail below, the position and shape of the surface of the voxel object (e.g., the mesh described below) are determined based on the density.

In the present example, the density can take an integer value within a range from a lower limit value (e.g., 0) to an upper limit value (e.g., 255). In the present example, the game system 1 determines a surface shape of the voxel object, based on the density such that the proportion of the volume that the area in the voxel object occupies in the voxel tends to be greater when the density value set for the voxel is higher, and the proportion tends to be smaller when the density value is lower. Thus, the density is an index that has an influence on the proportion of the volume that the area in the voxel object occupies in the voxel. The density can also be regarded as an index that indicates the degree of virtual occupation of the content (e.g., the virtual content of the voxel object) in the space of the voxel. For example, when the density is 0, the voxel is empty. When the density is 255, the entire space in the voxel is the content of the voxel object. When the density is a value between 0 and 255, the content of the voxel object occupies the space in the voxel based on (e.g., in a proportion according to) the value. The shape of the mesh, e.g., the surface shape of the voxel object, can be determined based on the density. The mesh can be regarded as the surface of a part, of a voxel, in which the content exists, or as a boundary between a part, of a voxel, in which the content exists and a part, of the voxel, in which the content does not exist. The volume that the area in the voxel object generated based on the density occupies may not necessarily be the volume that exactly matches the proportion indicated by the density. For example, the volume of the voxel object may differ between the method for generating a voxel object as shown in FIG. 8 and the method for generating a voxel object as shown in FIG. 13 even if these methods are based on the same density.

In other examples, the density may indicate either a state in which the volume of the area in the voxel object occupies the entire area in the voxel or a state in which the volume of the area in the voxel object is not included in the area in the voxel. For example, the density data may be data that can take only 0 or 1.

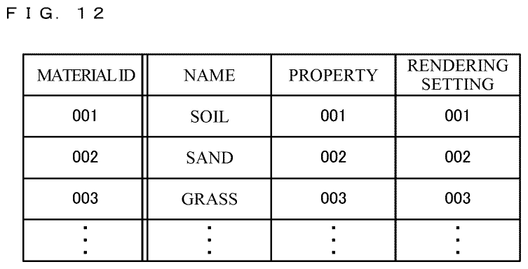

The first material ID and the second material ID are information indicating materials of the corresponding voxel. In the present example, a material such as sand, rock, or soil is set for a voxel. In the game system 1, multiple types of materials are prepared as materials that can be set for voxels (see material data shown in FIG. 12). In the present example, at most two materials out of the prepared multiple types of materials can be set for one voxel. The first material ID is an ID indicating a first material set for the voxel, and the second material ID is an ID indicating a second material set for the voxel. As will be described in detail below, a material of a voxel object (e.g., a material to be set for a polygon of the voxel object) is determined based on the materials set for voxels.

As described above, in the present example, the voxel data includes the ID indicating the material. However, in other examples, the voxel data may have a data structure that includes data directly indicating the details of the material (e.g., information on the name, property, and rendering setting described below).

The material mixing ratio data is an example of data indicating a ratio of materials in the voxel. In the present example, since at most two material IDs are set for one voxel, the material mixing ratio data, which indicates the ratio of one of the material indicated by the first material ID and the material indicated by the second material ID, can also indicate the ratio of the other material. In the present example, it is assumed that the material mixing ratio is a value indicating the ratio of the second material to the entire material consisting of the first material and the second material. The value is 0 or more and 1 or less. For example, if the material mixing ratio set for a certain voxel is 0.4, this indicates that the voxel is composed of the first material and the second material in the ratio of 0.6:0.4. As will be described in detail below, the appearance and property of the voxel object are determined based on the materials. The material mixing ratio is used to determine the appearance and property of the voxel object. In other examples, the material mixing ratio may be a value indicating the proportion of the first material. The ratio of the materials in the voxel may be indicated by the values of the proportions of the materials. In particular, in other examples, if the number of settable types of materials is not limited to two at most and three or more types of materials can be set, the ratio of the materials in the voxel is indicated by a plurality of values respectively indicating the proportions of the materials.

In the present example, two types of materials may not necessarily be set for a voxel, and one type of material may be set. For example, if one type of material is set for a certain voxel, the first material ID indicates this material, and the material mixing ratio is set at 0.

The state data indicates a state that is set for the corresponding voxel. The specific content of state data and the number of types thereof are discretionary. In the present example, the state data includes data indicating the amount of damage set on the voxel. In other examples, the state data may include data indicating whether or not the voxel is wet (and its extent), for example.

As described above, in the present example, since the voxel data includes the material ID, the game system 1 stores therein material data that defines the content of the material indicated by the material ID. FIG. 12 shows an example of the material data. As shown in FIG. 12, in the material data according to the present example, for each material, a material ID is associated with information about a name, property, and rendering setting that are set for the material.

The name included in the material data is a name (e.g., soil, sand, grass, etc.) set for the material. It should be noted that during the game, the name of the material of the voxel object may be displayed. In order to perform such a display, the material data includes information on the name of the material.

The property included in the material data is a property set for the material. The property of the material is a property that the voxel object, on which the material is set, possesses in the game. The specific content of the property of the material, and the number of types of properties are discretionary. For example, at least one of the following pieces of information may be set as properties of a material.
Hardness
Weight
Slipperiness
Damage setting in the case where the player character comes into contact with the voxel object
Temperature
Whether another object can be bonded to the voxel object
Amount of hit points to be regained by the player character when the player character destroys or acquires the voxel object
Amount of in-game currency to be gained by the player character when the player character destroys or acquires a voxel object

In other examples, information different from those listed above may be set as information indicating a property of a material.

In the present example, the material data includes, as information that identifies a property of a material, an ID indicating the property (see FIG. 12). Although not shown in FIG. 12, the game system 1 stores, for each property to be prepared, property information in which the property ID is associated with the content of the property (e.g., a value indicating the aforementioned hardness or slipperiness). By referring to the property information, the game system 1 can specify the specific content of the property set for the material.

The rendering setting included in the material data is information that indicates setting regarding rendering, such as a texture used for rendering of the voxel object for which the material is set. In the present example, the material data includes, as information on rendering setting, an ID of a texture to be used for rendering the voxel object for which the material is set (see FIG. 12). Although not shown in FIG. 12, the game system 1 stores, for each texture prepared, texture information in which the texture ID is associated with the texture indicated by the texture ID. By referring to the texture information, the game system 1 can specify the specific content of the texture set for the material. In other examples, as information on rendering setting, any information regarding setting of shading may be set in addition to the texture information. For example, information regarding reflectivity, normal, or the like may be set.

The material data may include data other than the data shown in FIG. 12. For example, the material data may include data regarding sound setting. For example, the data regarding the sound setting may be data that defines the sound of footsteps that is outputted when the player character walks on the voxel object based on the voxel.

The material data may be data of any form capable of specifying the property and/or rendering setting of the material. For example, in other examples, the material data may have a data structure including data that directly indicates the property and/or rendering setting of the material, instead of the data structure including the material ID and the texture ID.

### [2-2. Update of Voxel Data]

During the game, the voxel object is deformed when the voxel data is updated. In the present example, when a game event for updating the voxel object (hereinafter referred to as “update event”) has occurred, the game system 1 updates the voxel data. The update event may have any content. For example, the update event may be that a character that appears in the game has performed an action to deform the voxel object (e.g., the player character has punched the voxel object), or may be that an event that deforms the voxel object has occurred (e.g., contact of an object thrown by a character with the voxel object, or explosion of a bomb).

FIG. 13 shows an example of a game space when an update event has occurred. In the situation shown in FIG. 13, a player character 201 has performed a punching action to a terrain object 202 that is a voxel object. As will be described in detail below, in the example shown in FIG. 13, the voxel data is updated such that the terrain object 202 at and around a position hit by the punching action of the player character 201 is deleted. This represents how the terrain object 202 is destroyed by the punching action of the player character 201.

In the present example, when such an update event has occurred, the game system 1 sets, in the game space, an update range in which the voxel object is updated (in the example shown in FIG. 13, an update range 203). The position, shape, and size of the update range are discretionary. The position of the update range may be determined based on, for example, a position at which an object regarding the generated update event (e.g., the player character that has punched) comes into contact with the voxel object. In the example shown in FIG. 13, the position of the update range 203 may be determined based on a position that is hit by the punch of the player character 201. For example, the hit position, or a position a predetermined distance ahead of the hit position may be a center position of the update range 203. The shape and size of the update range may be determined in advance according to the type of the update event. For example, when an update event due to a punch of the player character 201 has occurred, the shape and size of the update range may be determined such that the update range is in the shape of a sphere having a predetermined size as shown in FIG. 13. The size of the update range may be determined based on a value indicating the degree of influence of the generated update event (e.g., the intensity of the punch, or the magnitude of the explosion).

The game system 1 changes the density of a voxel corresponding to the set update range. The voxel corresponding to the update range is, for example, a voxel within the update range or a voxels overlapping the update range. As a result of the change in the density, the mesh of the voxel object is changed by a process described below, thereby changing the shape of the voxel object (the shape by appearance, and the shape used for contact determination). In other examples, in addition to changing the density of the voxel included in the update range, the game system 1 may change the material in the voxel (e.g., the first material, the second material, and the material mixing ratio), or may change the state in the voxel.

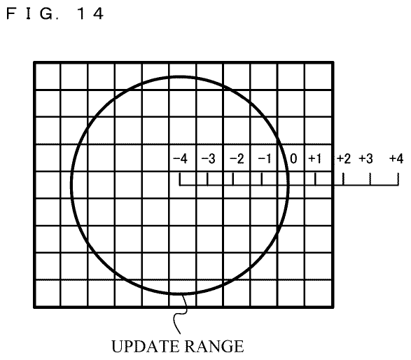

In the present example, the game system 1 determines whether or not a voxel is included in the update range, by using an SDF (Signed Distance Field). The game system 1 sets an SDF indicating an update range set in the game space, and performs the aforementioned determination based on the value of the SDF. The SDF represents distances, with signs, of any positions from a shape that the SDF defines. FIG. 14 shows an example of the update range. In the example shown in FIG. 14, a spherical update range is set in the game space. For example, in the example shown in FIG. 14, an SDF is set such that, among positions in the game space, positions inside the shape represented by the SDF have negative SDF values, and positions outside the shape represented by the SDF have positive SDF values. In this example, whether or not each position is included in the update range can be determined depending on whether or not the SDF value is positive or negative. In addition, using the SDF values allows not only simple inside/outside determination but also a process such as correction or interpolation.

In the example described above, a change in which the voxel object within the update range is deformed as if it is deleted, is applied to the voxel object. However, a change to be applied to the voxel object by using the update range is not limited thereto. For example, a change in which a voxel object is newly added in the update range (e.g., the volume that an area in the voxel object occupies is increased by the update range) may be applied to the voxel object. A change in which only the voxel material within the update range is changed while the voxel density is not changed, may be applied to the voxel object. A change in the voxel density and a change in the voxel material may be integrally applied.

### [2-3. Calculation of Vertices]

When the voxel density has been updated as described above, the game system 1 sets vertices based on the updated voxel data. The vertices can be vertices of a mesh of a voxel object. As will be described in detail below, in the present example, the vertices are simplified, and the simplified vertices become the vertices of the mesh of the voxel object.

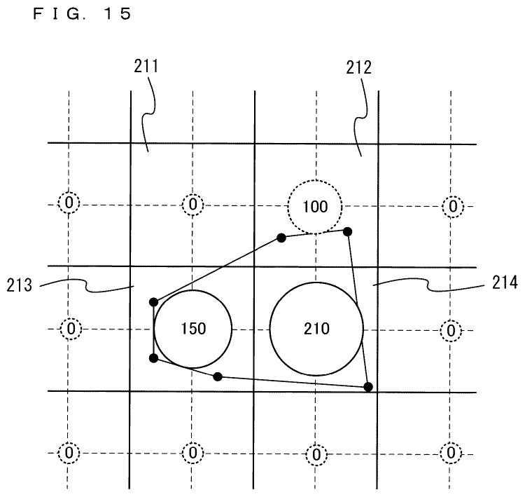

FIG. 15 shows an example of a method for setting vertices. In FIGS. 15 to 24, voxels, vertices, meshes, etc., are represented in two dimensions for the purpose of making the drawings easily viewable, and the description easily understandable. However, in actuality, vertices and meshes are set in a three-dimensional space, based on voxels in the three-dimensional space. In the present example, the game system 1 executes a method in which, for a portion where a voxel having a density that is set to a value indicating “existence” (e.g., a density equal to or greater than a reference value described below) is adjacent to a voxel having a density that is set to a value indicating “nonexistence” (e.g., a density less than the reference value described below), a vertex is set at coordinates based on the positions and densities of a plurality of neighboring voxels around the portion. Hereinafter, this method will be described in detail.

As described above, in the present example, the density set for a voxel is in the range of 0 to 255. A voxel having a density of 0 is completely empty, and a voxel having a density of 255 is completely filled up. Densities between 0 and 255 are complementarily treated, and are used for determining a vertex. In the present example, voxels are virtually treated such that voxels whose densities are equal to or greater than a reference value are inside a voxel object, and voxels whose densities are less than the reference value are outside the voxel object. It is also possible to virtually treat voxels such that voxels whose densities are equal to or greater than the reference value are voxels indicating “existence”, and voxels whose densities are less than the reference value are voxels indicating “nonexistence”. It is not necessary to define only voxels having a density of 0 as being outside the voxel object (e.g., reference value=1), and the reference value may be set to, for example, 128. In the example shown in FIG. 15, a voxel 211 and the other outer voxels have a density of 0, a voxel 212 has a density of 100 which is less than the reference value (e.g., 128), and voxels 213, 214 respectively have densities of 150, 210 which are greater than the reference value. In the present example, the game system 1 generates vertices between the voxels whose densities are equal to or greater than the reference value and the voxels whose densities are less than the reference value. Specifically, for each region (region delimited by dotted lines) that straddles eight (four in the diagram) adjacent voxels, it is determined whether or not to generate a vertex. That is, a vertex is generated in each region that straddles both a voxel whose density is equal to or greater than the reference value and a voxel whose density is less than the reference value. The coordinates of each vertex are determined by comparing the densities of adjacent voxels and performing interpolation based on the difference in density for each of the XYZ axes. Normal information that defines positions and directions of straight lines connecting the vertices may be set in advance, whereby the coordinates of each vertex can be calculated based on the normal information. The normal information may be stored in advance for at least some of the voxels, or if not stored, the normal information may also be calculated based on the densities between adjacent voxels. In FIG. 15, since the density of the voxel 212 is less than the reference value, the voxel 212 is treated as being outside the voxel object in the determination of presence/absence of a vertex, but the density value itself of the voxel 212 is used to calculate the coordinates of the vertices to be generated. If the reference value is set to a value lower than the density of the voxel 212, it would result in an increase in the vertices on the upper right side and the upper left side in the voxel 212 shown in FIG. 15.

By setting the vertices as described above, it is possible to generate a shape whose volume is based on (e.g., reflects) the density of each voxel to some extent, in generating a mesh connecting the set vertices (or vertices obtained by subjecting the set vertices to a simplification process described below). However, depending on the relationship with the neighboring voxels, a voxel having a density of 0 may partially include a region inside the voxel object, or a voxel having a density of 255 may partially include a region outside the voxel object. In the present example, since voxels having densities less than the reference value are treated as being outside the voxel object, there are fewer vertices as compared with a case where those voxels are treated as being inside the voxel object, and the volume will be smaller accordingly. That is, there is no need to calculate the polygon mesh so that the volume strictly corresponds to the density value.

### [2-4. Determination of Material of Vertex]

The game system 1 determines a material for each of the vertices set as described above. The material of the vertex is determined based on materials regarding voxels around this vertex. The voxels around the vertex are, for example, voxels used for determining whether or not to generate the vertex (e.g., voxels overlapping the aforementioned region that straddles voxels). In other examples, the voxels used for determining the material of the vertex and the voxels used for determining generation of the vertex may not necessarily be the same, and may be different from each other.

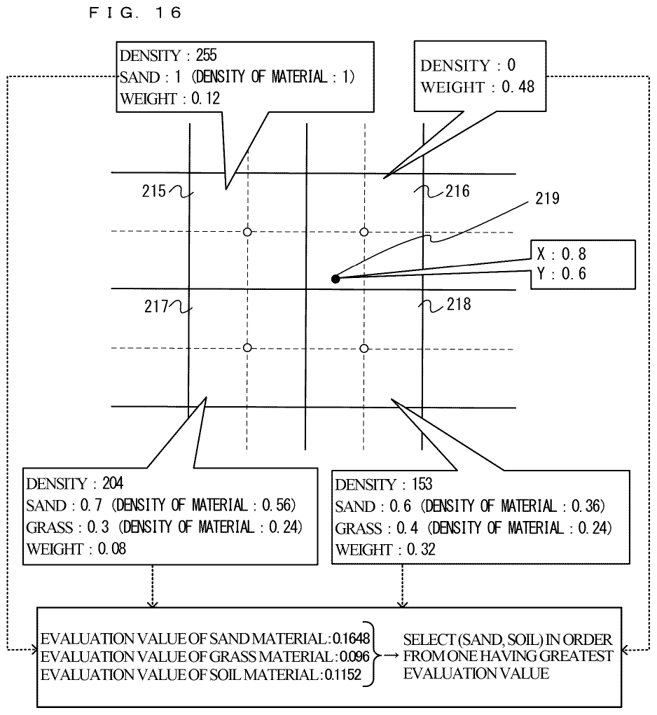

FIG. 16 shows an example of a method for determining a material of a vertex. In the example shown in FIG. 16, a vertex 219 is set with respect to four voxels 215 to 218, and the four voxels 215 to 218 correspond to the aforementioned “voxels around the vertex”. In an actual three-dimensional space, the number of voxels around the vertex is eight. In the example shown in FIG. 16, as for the voxel 215, a density of 255, a first material of “sand”, and a material mixing ratio of 0 (e.g., first material:second material=1:0, or the second material may not necessarily be set) are set. As for the voxel 216, a density of 0 is set (the first and second materials may not necessarily be set). As for the voxel 217, a density of 204, a first material of “sand”, a second material of “grass”, and a material mixing ratio of 0.3 (e.g., first material:second material=0.7:0.3) are set. As for the voxel 218, a density of 153, a first material of “soil”, a second material of “grass”, and a material mixing ratio of 0.4 (e.g., first material:second material=0.6:0.4) are set. In addition, the coordinates indicating the position of the vertex 219 are (X, Y)=(0.8, 0.6). A coordinate system for the coordinates has an X coordinate in the left-right direction and a Y coordinate in the up-down direction, in FIG. 16. In the coordinate system, among center positions of the voxels 215 to 218 (positions of white circles in FIG. 16), the center position of the lower-left voxel 217 is (0, 0).

In determining a material of the vertex, the game system 1 calculates an evaluation value for each of the materials of the neighboring voxels, based on the density of the material, and a weight value based on the distance from the voxel to the vertex. First, the weight value is calculated for each voxel. The shorter the distance from the center position of the voxel to the vertex is, the greater the weight value is. In the present example, assuming that the center position of a certain voxel is (x1, y1) and the coordinates of the vertex are (x2, y2), a weight value for the voxel is calculated according to the following formula (1).

(weight value)=|(1−x1)−x2|·|(1−y1)−y2| (1)

In the example shown in FIG. 16, the weight values of the voxels 215 to 218 calculated according to the formula (1) are as follows.

(weight value of voxel 215)=|(1−0)−0.8|·|(1−1)−0.6|=0.12

(weight value of voxel 216)=|(1−1)−0.8|·|(1−1)−0.6|=0.48

(weight value of voxel 217)=|(1−0)−0.8|·|(1−0)−0.6|=0.08

(weight value of voxel 218)=|(1−1)−0.8|·|(1−0)−0.6|=0.32

The game system 1 calculates a density of a material for each voxel. Here, the density of the material is a value obtained by multiplying the proportion of this material, among materials set for the voxel, by the density of the voxel. In the present example, for the densities of the voxels, values obtained by normalizing the aforementioned values from 0 to 255 to values from 0 to 1 are used. In the example shown in FIG. 16, as for the voxel 215, since the material set for this voxel is only sand, the proportion regarding the sand material is 1, and the density of the voxel is 1, and therefore, the density of the sand material is 1. As for the voxel 216, since the density is 0 and no material is set, a material density is not calculated. If any material is set, the density of this material is 0. As for the voxel 217, the proportions of the sand material and the grass material being set are 0.7 and 0.3, respectively, and the density of the voxel is 204/255=0.8. Therefore, the density of the sand material is 0.7·0.8=0.56, and the density of the grass material is 0.3·0.8=0.24. As for the voxel 218, the proportions of the soil material and the grass material being set are 0.6 and 0.4, respectively, and the density of the voxel is 153/255=0.6. Therefore, the density of the soil material is 0.6·0.6=0.36, and the density of the grass material is 0.4·0.6=0.24.

Then, the game system 1 calculates the evaluation value for each material, based on the weight value and the density of the material. In the present example, the evaluation value of the material is a value obtained by weighting the density of the material calculated for each voxel, according to the weight value of the voxel, and summing up the weighted densities of the neighboring voxels. In the example shown in FIG. 16, the evaluation value of the sand material is 1.0·12+0.56·0.08=0.1648 because the density of the material is 1 and the weight value is 0.12 for the voxel 215, and the density of the material is 0.56 and the weight value is 0.08 for the voxel 217. The evaluation value of the grass material is 0.24·0.08+0.24·0.32=0.096 because the density of the material is 0.24 and the weight value is 0.08 for the voxel 217, and the density of the material is 0.24 and the weight value is 0.32 for the voxel 218. The evaluation value of the soil material is 0.36·0.32=0.1152 because the density of the material is 0.36 and the weight value is 0.32 for the voxel 218.

The game system 1 determines a material of the vertex, based on the evaluation values of the respective materials. Specifically, a predetermined number of materials in order from one having the greater evaluation value are determined as materials of the vertex. In the present example, two materials having the first and second greatest evaluation values are determined as materials of the vertex. In the example shown in FIG. 16, since the evaluation values of the sand, grass, and soil materials are 0.1648, 0.096, and 0.1152, respectively, the sand material and the soil material are determined as the materials of the vertex. Furthermore, the game system 1 calculates the ratio of the determined two materials, based on the evaluation values described above. In the present example, the ratio of the two materials may be represented as a second material ratio that is a ratio of the second material to the whole, like the aforementioned material mixing ratio. In the example shown in FIG. 16, for example, if the first material and the second material are set to soil and sand, respectively, the second material ratio is represented as 0.1648/(0.1648+0.1152)≈0.59. In other examples, as a value representing the ratio of the two materials, a value representing the proportion of the first material may be used. Alternatively, values representing the proportions of the respective materials may be used.

In the present example, the game system 1 generates and stores therein vertex data indicating the position of a vertex, material IDs of the first and second materials set for the vertex, and the ratio of the materials. However, the method for managing materials set for a vertex is discretionary. In other examples, the vertex data may have a data structure including data that directly indicates the contents of the first and second materials.

As described above, in the present example, regarding material IDs included in voxel data of a plurality of neighboring voxels around each vertex, the game system 1 calculates a priority parameter (e.g., evaluation value) for each material ID, based on the voxel data. Then, based on the priority parameters, the game system 1 selects a predetermined number of (here, two) material IDs having the higher priorities, and determines the selected material IDss as material IDs for the vertex. The specific parameter to be used as the priority parameter is not limited to the evaluation value. For example, in other examples, an evaluation value that is calculated using the density of the material without using the weight value may be used as a priority parameter.

In the present example, the evaluation value as an example of the priority parameter is calculated based on the densities of the plurality of neighboring voxels around the vertex such that the material set for the voxel having the higher density has the higher priority (e.g., the evaluation value of the material is increased and thereby the material is highly likely to be selected). Thus, the material of the vertex can be determined while also incorporating (e.g., reflecting) the magnitude of the density set for the voxel.

In the present example, the evaluation value as an example of the priority parameter is calculated based on the distances from reference positions (specifically, center positions) of a plurality of neighboring voxels around the vertex, to the vertex such that the material set for the voxel closer to the vertex has the higher priority. Thus, the material of the vertex can be determined while also incorporating (e.g., reflecting) the distances between the voxels and the vertex.

In the present example, it can also be said that the evaluation value as an example of the priority parameter is calculated based on the material mixing ratios of a plurality of neighboring voxels around the vertex such that the material having the higher material mixing ratio has the higher priority. Thus, in the case where a plurality of materials are set for one voxel, the material of the vertex can be determined while also incorporating (e.g., reflecting) the ratio of the materials.

### [2-5. Simplification of Vertices]

In the present example, the game system 1 simplifies the vertices calculated as described above. That is, the game system 1 replaces some of the vertices calculated as described above with one vertex to decrease the number of vertices. As will be described in detail below, the coordinates (e.g., position) and the material of the replacing vertex are set based on a plurality of vertices before replacement. Such simplification can reduce the numbers of vertices and polygons that form a mesh of a voxel object, thereby reducing the amount of memory used for processing, and reducing the processing load.

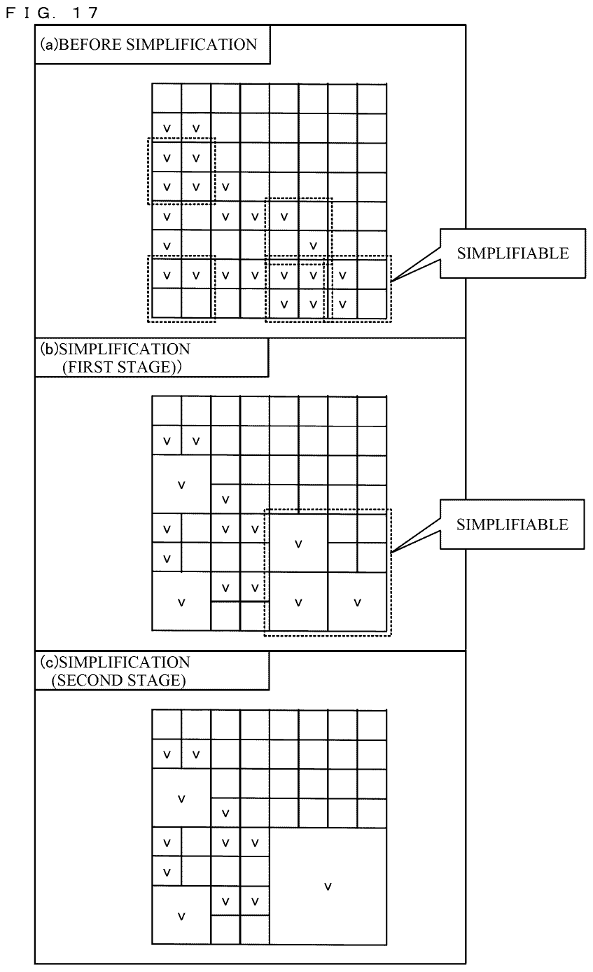

In the present example, the game system 1 performs simplification by representing vertices using SVO (Sparse Voxel Octree). FIG. 17 shows an example of vertex simplification. In FIG. 17, one square delimited by solid lines in (a) represents one vertex division region. Here, the vertex division region is a square region with a center position of a voxel being a vertex (in an actual three-dimensional space, the vertex division region is a cube or a rectangular parallelepiped), and corresponds to a region with the dotted lines being sides shown in FIG. 15 and FIG. 16. In FIG. 17, each vertex division region having a character “v” inside is a vertex division region in which a vertex is set.

In the present example, the game system 1 determines whether or not simplification can be performed with respect to the vertices in a predetermined number of (four in FIG. 17, and eight in an actual three-dimensional space) vertex division regions adjacent to each other. If the determination result is that simplification can be performed, simplification is performed for the vertices in the predetermined number of vertex division regions.

In FIG. 17, (a) shows the state before simplification is performed. In the example shown in FIG. 17, it is determined that simplification can be performed for vertex division regions within a range surrounded by dotted lines. In this case, the game system 1 performs simplification such that the vertices in the predetermined number of vertex division regions determined to be simplified are replaced with one vertex (see (b) shown in FIG. 17). Thus, the vertices in the predetermined number of vertex division regions are simplified to one vertex.

In the present example, the game system 1 performs simplification in a plurality of stages. The number of the stages is discretionary. In FIG. 17, first and second stages are shown and described. In FIG. 17, (b) shows the state in which the first-stage simplification has been performed, and (c) shows the state in which the second-stage simplification has been performed. In the second-stage simplification, whether or not simplification can be performed is determined for vertices that are generated by the first-stage simplification. In the example shown in FIG. 17, when the determination result is that the vertex division regions within a range surrounded by dotted lines in (b) shown in FIG. 17 can be subjected to simplification, the vertices in the vertex division regions are simplified, resulting in the state shown in (c) of FIG. 17. The condition for determining whether or not the first-stage simplification can be performed and the condition for determining whether or not the second-stage simplification can be performed may be the same or different from each other.

The specific method for determining whether or not simplification can be performed is discretionary. In the present example, as conditions for the above determination, a condition regarding the shape of the voxel object and a condition regarding the material of the voxel object are used. In the present example, if both the condition regarding the shape of the voxel object and the condition regarding the material of the voxel object are satisfied, it is determined that simplification can be performed. If at least one of the condition regarding the shape of the voxel object and the condition regarding the material of the voxel object is not satisfied, it is determined that simplification cannot be performed.

The condition regarding the shape is, for example, that there is no significant change between the shape due to the vertices before the simplification and the shape due to the vertices after the simplification. For example, determination as to whether or not there is a significant change in the shape due to the vertices before and after the simplification may be performed by calculating an index indicating an error between the mesh before the simplification and the mesh after the simplification, and determining whether or not the index is equal to or smaller than a predetermined allowable value. Furthermore, for example, if the shape due to the vertices after the simplification is not a hollow shape while the shape due to the vertices before the simplification is a hollow shape (e.g., the simplification causes missing of information that the shape is hollow), it is determined that the condition regarding the shape is not satisfied. Whether or not the aforementioned case will occur can be determined based on, for example, the densities of voxels corresponding to the vertex division regions to be subjected to the determination. Moreover, for example, if the shape due to the vertices before the simplification can be represented only by two or more vertices, e.g. it cannot be represented by one vertex, it is determined that the condition regarding the shape is not satisfied. As the condition regarding the shape of the voxel object, the same condition as that used for the conventional method with the SVO may be used.

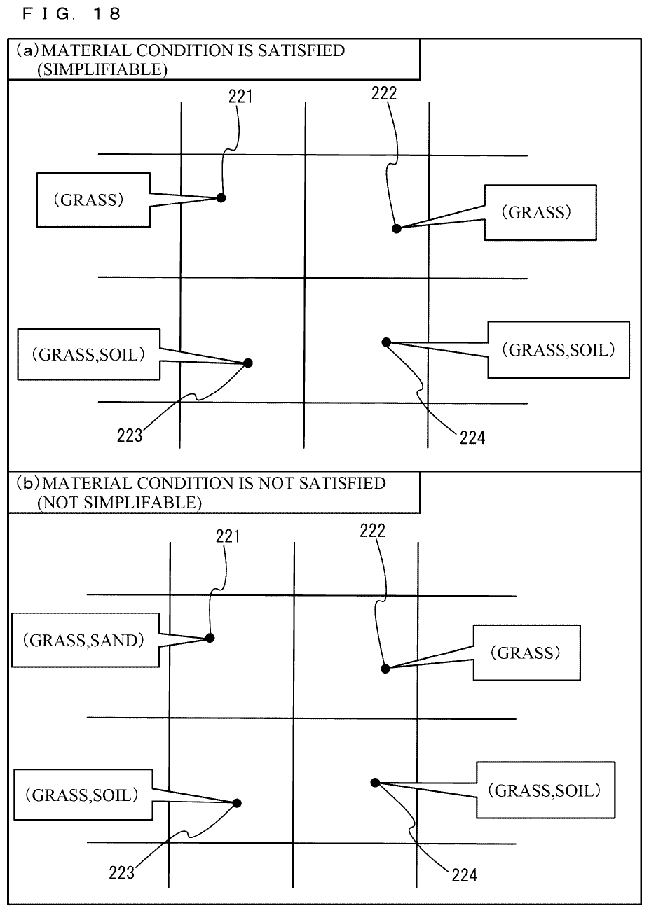

In the present example, as the condition regarding the material, a condition regarding the number of types of materials to be set for the vertices in the predetermined number of vertex division regions to be subjected to simplification, is used. FIG. 18 shows an example of the condition regarding the material. In FIG. 18, (a) shows a case where the materials of vertices 221 to 224 are “grass”, “grass”, “grass and soil”, and “grass and soil”, respectively, and (b) shows a case where the materials of the vertices 221 to 224 are “grass and sand”, “grass”, “grass and soil”, and “grass and soil”, respectively. In the present example, the condition regarding the material is that the total number of the types of materials set for the vertices to be subjected to simplification is equal to or less than a predetermined number. For example, the condition regarding the material is that the total number is equal to or less than the number of materials that can be set for one vertex. In the present example, the predetermined number is 2. For example, in the case of (a) shown in FIG. 18, since the total number of the types of materials set for the vertices 221 to 224 to be subjected to simplification is 2 (e.g., grass and soil), the condition regarding the material is satisfied. In this case, it is determined that the vertices 221 to 224 can be subjected to simplification on the condition that the aforementioned condition regarding the shape of the object is satisfied. On the other hand, in the case of (b) shown in FIG. 18, since the total number of the types of materials set for the vertices 221 to 224 to be subjected to simplification is 3 (e.g., grass, soil, and sand), the condition regarding the material is not satisfied. In this case, it is determined that the vertices 221 to 224 cannot be subjected to simplification regardless of whether or not the condition regarding the shape of the object is satisfied.

In the game system 1, multiple types of materials to which the same property is set and which are different in appearance may be prepared even though these materials should strictly be classified into different types. Some of the multiple types of materials may be regarded as being of the same type in determining whether the condition regarding the material is satisfied. For example, multiple types of soil materials having the same property and similar appearances (e.g., texture colors or patterns) may be prepared. In this case, the game system 1 may determine whether the condition regarding the material is satisfied while regarding the multiple types of soils as being of the same type.

In the present example, at most two types of materials can be set for a vertex as in the case of a voxel. Meanwhile, in the present example, if the total number of the types of materials set for the vertices to be subjected to simplification is three or more, simplification is not performed. That is, if the total number of the types of materials exceeds the number of materials that can be set for one vertex, simplification is not performed. Therefore, even when the number of vertices is reduced through simplification, the simplification does not cause missing of information on the materials set for the vertices, thereby maintaining the information on the materials.

In the present example, a material of the vertex after the simplification is determined based on the materials of the vertices before the simplification. Specifically, the game system 1 sets the one or two types of materials set on the vertices before the simplification, as the first material and the second material of the vertex after the simplification. This allows the information on the materials to be maintained. The ratio of the materials after the simplification is determined based on the ratio of the materials of the vertices before the simplification. In the present example, the radio of the materials after the simplification is calculated similarly to the aforementioned method for calculating the ratio of materials of vertices by using the evaluation values. That is, the game system 1 calculates weight values based on the distances between the vertex after the simplification and the vertices before the simplification, and calculates an evaluation value for each material, based on the weight values and the densities of the materials of the vertices before the simplification (the evaluation values of the materials described in the above [2-4. Determination of material of vertex] can be used as the densities of the materials here). Then, the ratio of the materials is calculated based on the calculated evaluation values of the materials.

### [2-6. Generation of Mesh]

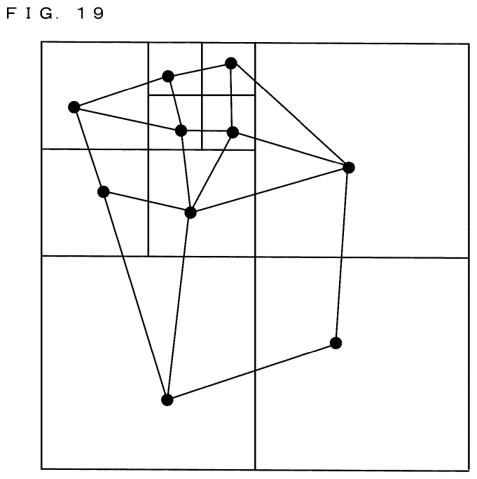

In the present example, a mesh of a voxel object is generated based on vertices having been simplified as described above. FIG. 19 shows an example of a mesh generated based on such vertices. Each of squares shown in FIG. 19 represents a vertex division region as described above, or a vertex division region obtained by integrating a plurality of vertex division regions through simplification. As shown in FIG. 19, the game system 1 generates a mesh that is composed of polygonal shapes each having, as one side, a straight line connecting vertices of adjacent vertex division regions. Each of the polygonal shapes forming the mesh is a triangle or a quadrangle.

In the present example, the game system 1 generates two types of meshes—e.g., a display mesh and a determination mesh. The display mesh is a mesh used for displaying a voxel object. The determination mesh is a mesh used for collision determination for a voxel object. As will be described in detail below, by using the two types of meshes, the game system 1 can perform processing with the meshes suitable for display of the voxel object and collision determination, respectively.

In the present example, the game system 1 generates the display mesh and the determination mesh, based on data of the SVO described above (e.g., based on the simplified vertices). Thus, sharing vertex data in generating the two types of meshes improves efficiency of processing. In other examples, the game system 1 may not necessarily perform simplification of vertices, and may generate a display mesh and/or a determination mesh, based on vertices that are not simplified.

In the present example, the game system 1 generates the determination mesh so as to be simpler in shape than the display mesh. Specifically, the game system 1 makes the number of vertices of the determination mesh less than the number of vertices of the display mesh. Here, in the present example, the data of the SVO holds, in an octree data structure, data of vertices before simplification and data of simplified vertices, and also includes data used for determining whether or not simplification can be performed. This data includes, for example, data of vertices (referred to as “provisional vertices”) calculated as candidates for a vertex after simplification, and data of the aforementioned index indicating an error between the vertices before simplification and the provisional vertices. For example, the game system 1 may use, among the provisional vertices, a vertex the index of which is equal to or less than a predetermined threshold value (this threshold value is greater than the aforementioned allowable value), for generation of the determination mesh. This allows the number of vertices of the determination mesh to be less than the number of vertices of the display mesh. The number of vertices of the determination mesh being less than the number of vertices of the display mesh allows a reduction in processing load for collision determination. Moreover, since the number of vertices of the display mesh is not excessively reduced, the appearance of the voxel object can be represented in detail.

In other examples, the display mesh and the determination mesh may be generated based on the same data, or may be generated based on different data. The display mesh and the determination mesh may have the same shape (even in this case, materials set for these meshes may be different from each other). The number of vertices of the determination mesh may be equal to the number of vertices of the display mesh, or may be greater than the number of vertices of the display mesh.

### [2-6-1. Determination of Material of Display Mesh]

Next, an example of a method for determining materials and an appearance of a display mesh will be described. In the present example, the game system 1 determines a material for each of the polygonal shapes forming the display mesh. As will be described in detail below, in the present example, a polygon corresponding to each polygonal shape is rendered using at most two types of textures corresponding to at most two types of materials. Therefore, the game system 1 determines materials for the polygonal shapes forming the mesh such that two or less types of materials are finally set for one polygonal shape. In other examples, three or more materials may be set. For example, in an example in which three or more types of voxel materials and three or more types of vertex materials are set, the same number of materials may be set for the polygonal shapes.

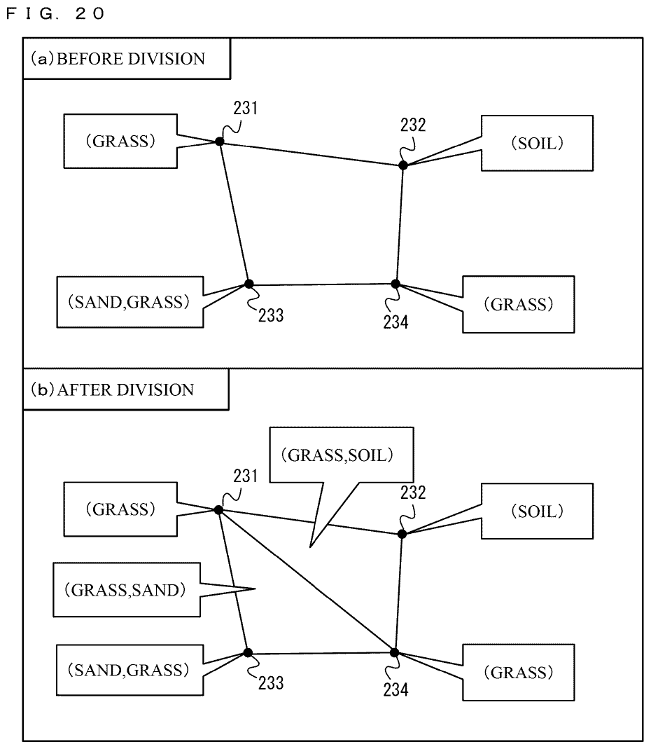

In the present example, quadrangles may be formed as polygonal shapes forming the display mesh (see FIG. 19). In determining materials of the display mesh, the game system 1 firstly divides each of the quadrangles forming the display mesh into two triangles under certain conditions. Hereinafter, a process of dividing a quadrangle into two triangles will be described with reference to FIG. 20.

FIG. 20 shows an example of dividing a quadrangle forming a mesh into two triangles. In FIG. 20, (a) shows a quadrangle before division, formed by vertices 231 to 234 included in the vertices of the mesh. In FIG. 20, (b) shows two triangles into which the quadrangle is divided. In the example shown in FIG. 20, “grass”, “soil”, “sand and grass”, and “grass” are set as materials of the respective vertices 231 to 234.

In the present example, if the number of types of materials set for the vertices of the quadrangle is three or more in total, the game system 1 determines whether or not a division condition is satisfied. In the present example, the division condition is that dividing the quadrangle into two triangles allows the number of types of materials set for the vertices of each triangle to be two or less in total. If the division condition is satisfied, the game system 1 divides the quadrangle into two triangles each having two or less types of materials set for the vertices. In the example shown in FIG. 20, three types of example materials, grass, soil, and sand, are set for the vertices 231 to 234 forming the quadrangle. If the quadrangle is divided into a triangle formed by the vertices 231, 232, 234 and a triangle formed by the vertices 231, 233, 234, two types of materials, sand and grass, are set for the vertices of the former triangle, and two types of materials, grass and soil, are set for the vertices of the latter triangle (see (b) shown in FIG. 20). Since the division condition is satisfied for the quadrangle, the game system 1 divides the quadrangle into two triangles.

Since there are two methods for dividing a quadrangle into two triangles, if the division condition is satisfied for the triangles into which the quadrangle is divided by at least one of the two methods, the game system 1 performs the division by the method satisfying the division condition. Meanwhile, if the division condition is not satisfied for the triangles into which the quadrangle is divided by either of the two methods, the game system 1 performs the division by either method.

By performing the division as described above, the game system 1 can generate two triangles each having two or less types of materials set for the vertices, without missing information on three or more types of materials set for the vertices of the quadrangle as much as possible. Here, as described above, each of the polygons forming the mesh is rendered using at most two types of textures. Therefore, by performing the division, the game system 1 can render each polygon by using two types of textures without missing information on the materials set for the vertices as much as possible.

In the present example, the game system 1 sets polygons corresponding to the polygonal shapes obtained through the aforementioned division. That is, the vertices of the polygonal shapes obtained through the division become the vertices of the polygons of the display mesh.

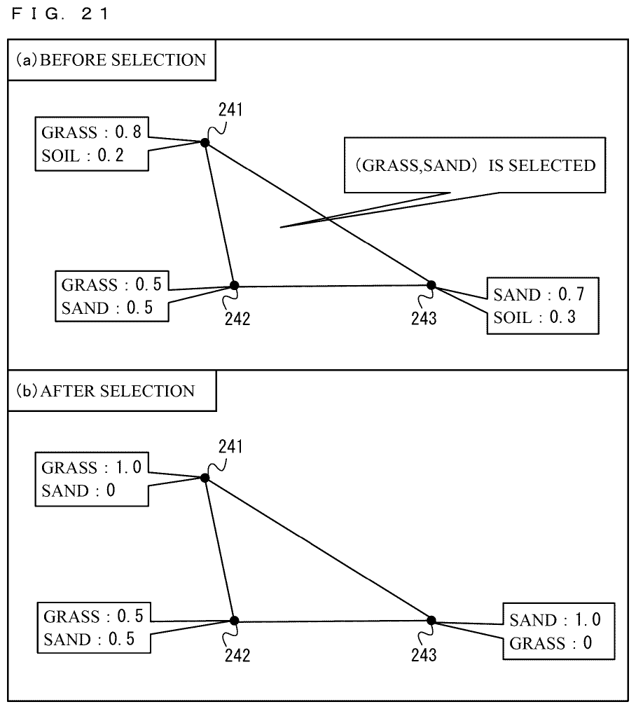

In the present example, as for the polygons forming the display mesh, if the number of types of materials set for the vertices of one polygon is three or more in total, the game system 1 selects two types of materials to determine materials of this polygon. FIG. 21 shows an example of a method for determining materials of a polygon forming the display mesh. In the example shown in FIG. 21, as for a vertex 241 of a triangular polygon forming the display mesh, the first material is “grass”, the second material is “soil”, and the material ratio of the first material to the second material is 0.8:0.2. As for a vertex 242 of the polygon, the first material is “grass”, the second material is “sand”, and the material ratio of the first material to the second material is 0.5:0.5. As for a vertex 243 of the polygon, the first material is “sand”, the second material is “soil”, and the material ratio of the first material to the second material is 0.7:0.3.

If the number of types of materials set for the vertices of the polygon is three or more in total, the game system 1 calculates a determination value for each material. The determination value is calculated as a sum of the proportions of the material at the vertices on which the material is set. Then, the game system 1 selects two materials in order from one having the greatest determination value, as materials of the polygon. In the example shown in FIG. 21, the determination value of the grass material is 0.8+0.5=1.3, the determination value of the sand material is 0.5+0.7=1.2, and the determination value of the soil material is 0.2+0.3=0.5. Therefore, the grass material and the sand material are selected as materials of the polygon shown in FIG. 21 (see (a) shown in FIG. 21).

The specific method for selecting a material of a polygon of the display mesh is discretionary. In other examples, a material of a polygon of the display mesh may be selected by any method based on information set for the vertices of the polygon. For example, a material of a polygon of the display mesh may be selected as follows. That is, a material having the greatest proportion at one vertex is specified for each vertex, and a material that is most frequently specified for each vertex is selected as a material of the polygon.

In the present example, the selected materials of the polygon are indicated as materials set for the vertices of the polygon. That is, when the materials of the polygon have been selected, the game system 1 changes the materials being set for the vertices of the polygon (e.g., the material IDs included in the vertex data) to the selected materials. In the example shown in FIG. 21, as for the vertex 241 and the vertex 243, “grass and soil” and “sand and soil” are respectively set before the selection of materials of the polygon (see (a) shown in FIG. 21). When grass and sand have been selected as materials of the polygon as described above, the materials set for the vertex 241 and the vertex 243 are changed to “grass and sand” (see (b) shown in FIG. 21). Since the materials set for the vertex 242 before the selection are the same as the selected materials of the polygon, the materials are not changed. In the case where two types of materials are selected as materials of the polygon as described above, information on the third and subsequent types of materials set for the vertices of the polygon are deleted.

According to the change of the materials set for each vertex, the game system 1 changes the ratio of the materials set for the vertex. For example, as for the vertex 241, the content indicating that the first material is grass and the second material is soil is changed to the content indicating that the first material is grass and the second material is sand. Here, since the proportion of the sand material is 0, the material ratio of the first material to the second material becomes 1:0. Thus, the above change is formally changing the materials of the vertices of the polygon in order to represent the materials of the polygon by the materials of the vertices of the polygon.

According to the above, since the materials set for the vertices of one polygon are only the materials corresponding to the textures used for rendering described below, a rendering process using the textures can be easily performed.

There may be a case where the aforementioned change causes all the materials at a certain vertex to be changed (e.g., none of the materials after the change correspond to the materials before the change). For example, there is a case where the material set for the vertex before the change is soil, and the materials selected as materials of the polygon are grass and sand. In this case, the ratio of the materials at the certain vertex may be set based on the material ratios at the other vertices of the polygon. For example, in the above example, in the case where the first material set for one of the remaining two vertices of a triangular polygon is grass and the material ratio of grass to sand is 1:0 while the material set for the other vertex is sand and the material ratio of sand to grass is 1:0, the material ratio at the certain vertex may be set to grass:sand=0.5:0.5. The game system 1 may determine the material ratio at the certain vertex in consideration of the distance between this vertex and the other vertex (e.g., based on a weight value that increases as the distance is shorter).

As described above, in the present example, the game system 1 selects, for each polygon, at most a predetermined number of (here, two) material IDs from among the material IDs set for the vertices included in the polygon (e.g., material IDs set for the vertices of the polygonal shape corresponding to the polygon), and determines the selected material IDs as material IDs of the polygon. Thus, the game system 1 can perform the rendering process with the number of textures to be used being reduced, while incorporating (e.g., reflecting) the materials set for the vertices into the appearance of the polygon.

In the present example, regarding the materials of all the vertices forming a polygon, if the number of the materials is equal to or less than the predetermined number, the game system 1 determines the materials as materials of the polygon. Meanwhile, if the number of the materials exceeds the predetermined number, the game system 1 selects a predetermined number of materials having higher priorities, based on the priority parameters of the vertices (specifically, based on the determination values calculated based on the aforementioned evaluation values), and determines the selected materials as materials of the polygon. Thus, even if the number of the materials set for the vertices exceeds, in total, the predetermined number, the number of the materials of the polygon can be made equal to or less than the predetermined number in consideration of the priority.

As described above, in the present example, the first and second materials set for each of the vertices of one polygon are changed to the two types of materials to be set for the polygon. In performing such a change, as for a vertex shared by adjacent two polygons, there is a possibility of inconsistency in the first and second materials to be set.

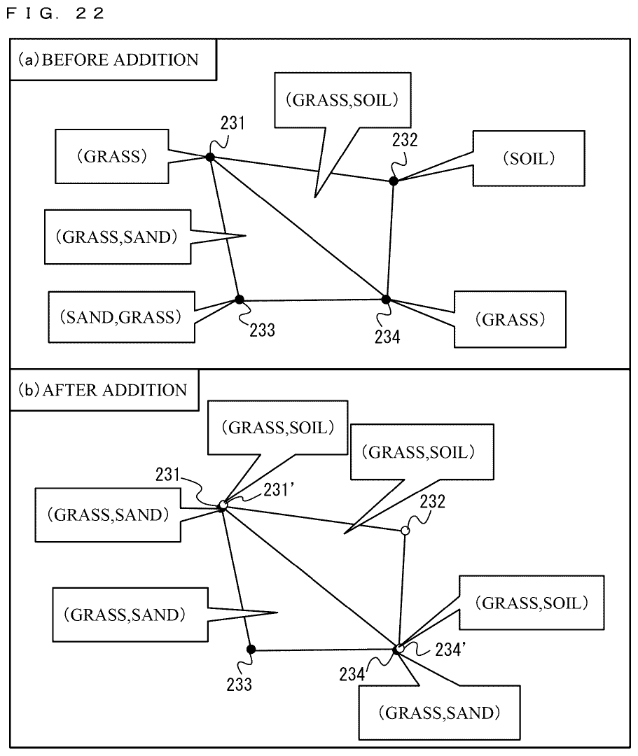

FIG. 22 shows an example of materials set for vertices of adjacent two polygons. FIG. 22 shows a state in which two polygons are formed by the vertices 231 to 234 shown in FIG. 20 ((b) shown in FIG. 20). In the example shown in FIG. 22, since grass and sand are determined as materials of a first polygon formed by the vertices 231, 233, and 234, the first and second materials of these vertices should be set to grass and sand, respectively. Meanwhile, since grass and soil are determined as materials of a second polygon formed by the vertices 231, 232, and 234, the first and second materials of these vertices should be set to grass and soil, respectively. Therefore, in the example shown in FIG. 22, as for the vertices 231 and 234 shared by the two polygons, inconsistency occurs in the materials to be set.

In the present example, when inconsistency occurs in material to be set for a vertex shared by two polygons, the game system 1 adds another vertex at the position of the vertex. In FIG. 22, (b) shows an example of a state in which a vertex 231′ is added for the vertex 231 and a vertex 234′ is added for the vertex 234. In the example shown in FIG. 22, the game system 1 sets, for the vertices 231 and 234, grass and sand as the first and second materials according to the materials of the first polygon. In addition, the game system 1 sets, for the vertices 231′ and 234′, grass and soil as the first and second materials according to the materials of the second polygon. By formally setting two vertices as vertices to be shared by two polygons (e.g., by generating data of two vertices located at the same position and having different materials), it is possible to inhibit occurrence of inconsistency in materials to be set for the vertices.

The game system 1 generates a display mesh composed of the polygons whose vertices and materials are determined as described above. In addition, the game system 1 renders the polygons, based on information on the materials set for the vertices (e.g., the first material and the second material), thereby rendering a voxel object.

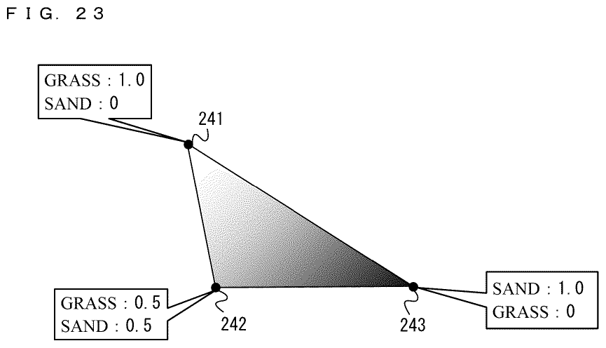

FIG. 23 shows an example of applying a texture to a polygon. FIG. 23 shows a triangular polygon formed by the vertices 241 to 243 shown in FIG. 21. The materials set for the vertices 241 to 243 are those shown in (b) shown in FIG. 21.

As for the position of a vertex of a polygon, rendering is performed by a mapping in which a texture of a first material set for the vertex and a texture of a second material set for the vertex are blended at a ratio of the materials set for the vertex (e.g., using this ratio as a blending ratio). The textures of the first and second materials used for the rendering are textures indicated by information on rendering setting associated with the material ID that is associated with data of the vertex in the aforementioned material data (see FIG. 12). In the example shown in FIG. 23, as for the position of the vertex 241, since the material ratio of grass to sand is 1:0, rendering is performed by using only the texture of grass. As for the position of the vertex 243, since the first material is sand and the material ratio of sand to grass is 1:0, rendering is performed by using only the texture of sand. As for the position of the vertex 242, since the first material is grass, the second material is sand, and the material ratio of grass to sand is 0.5:0.5, rendering is performed such that the texture of grass and the texture of sand are blended at a blending ratio of 0.5:0.5.

As for positions other than the vertices of the polygon, the game system 1 determines a blending ratio by interpolating the blending ratios at the vertices. Then, rendering is performed by a mapping in which the textures of two materials set for each vertex are blended at the interpolated blending ratio. The specific method for interpolation is discretionary. As an example, a blending ratio between vertices is subjected to linear interpolation. In FIG. 23, a position at which the texture of grass material is applied at a high ratio is shown in white, and a position at which the texture of sand material is applied at a high ratio is shown in black. In the example shown in FIG. 23, the texture of grass is applied to the vertex 241, and the blending ratio of the texture of sand increases toward the vertex 243. At the position of the vertex 242, the blending ratio of grass to sand becomes 1:1, and only the texture of sand is applied at the position of the vertex 243. Thus, rendering is performed with the two textures set for the polygon (e.g., set for the vertices of the polygon) being blended with the blending ratio according to the material ratio, whereby the appearance at the boundary between different materials can be made natural in the display mesh. This makes the appearance of the display mesh, in which a plurality of types of materials are set, natural.

### [2-6-2. Determination of Material of Determination Mesh]

Next, an example of a method for determining materials of a determination mesh will be described. As will be described in detail below, in the present example, there may be a case where collision determination is performed for a voxel object by using a determination mesh, and processing is performed according to a material of a voxel object for which a collision has been determined. Therefore, in the present example, materials are determined also for the determination mesh.

In the present example, the game system 1 sets polygons corresponding to the polygonal shapes forming the determination mesh such that one type of material is set for one polygon. Specifically, the game system 1 determines a material to be set for a polygon of the determination mesh, based on information on materials set for vertices of this polygon (e.g., information on first and second materials, and a material ratio).

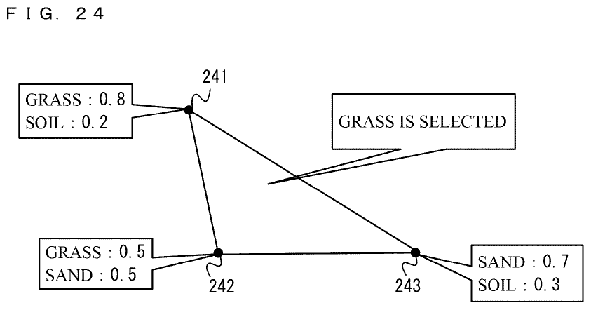

FIG. 24 shows an example of a method for determining a material of a polygon forming the determination mesh. FIG. 24 shows an example of determining a material for a triangular polygon formed by the vertices 241 to 243 shown in FIG. 21. The materials set for the vertices 241 to 243 are those shown in (a) shown in FIG. 21.

In determining a material of a polygon, the game system 1 calculates a determination value for each of materials set for the vertices of the polygon. In the present example, a calculation method for the determination value is identical to the calculation method for the determination value that is used for selection of the materials to be set for the polygonal shapes of the display mesh. The specific calculation method for the determination value is discretionary. In other examples, the determination value may be calculated in any method based on information set for the vertices of the polygon of the determination mesh.

In the example shown in FIG. 24, the determination value for each material is 1.3 for the grass material, 1.2 for the sand material, and 0.5 for the soil material as in the case shown in FIG. 21. Therefore, the grass material is selected as a material of the polygon shown in FIG. 24.

As described above, in the present example, the game system 1 selects, for each polygon, at most a predetermined number of (here, one) material IDs from among the material IDs set for the vertices included in the polygon (e.g., material IDs set for the vertices of the polygonal shape corresponding to the polygon), and determines the selected material ID as a material ID of the polygon. This allows the game system 1 to reduce the number of materials to be set for the determination mesh to the predetermined number or less. Thus, processing based on the material type, which is performed according to the result of collision determination using the determination mesh, is prevented from being complicated. The method for determining a material of a polygon of the determination mesh is discretionary, and is not limited to the above method. In other examples, a material of a polygon of the determination mesh may be determined by any method based on information set for the vertices of the polygon.

In the present example, one type of material is set for a polygon of the determination mesh while at most two types of materials are set for a polygon of the display mesh. Therefore, natural appearance can be achieved for the polygon of the display mesh by using two types of textures. In addition, as for the determination mesh, a process to be performed according to the result of collision determination using the determination mesh can be prevented from being complicated. In other examples, the types of materials settable for polygons of the display mesh and the determination mesh are discretionary. The number of materials settable for a polygon of the display mesh and the number of materials settable for a polygon of the determination mesh each may be plural, and may be the same or different from each other.

In the present example, the number of types of materials to be set for one voxel is two at most, and the number of types of materials to be set for one polygon in the display mesh is two at most. Thus, information on materials set in the voxel data can be used for (e.g., reflected in) the materials of the display mesh while reducing the data amount of the voxel data. Moreover, in the present example, the number of types of materials to be set for vertices based on the voxel data is also two at most (see FIG. 16). In this case, since two types of materials can be set also for vertices that are generated during the process to obtain the display mesh from the voxel data, the information on materials set in the voxel data used for (e.g., reflected in) the display mesh, without missing the information on materials during the process.

In other examples, the game system 1 may set materials such that, regarding vertices to be set based on the voxel data, materials set for vertices to be used for generation of the display mesh are different from materials set for vertices to be used for generation of the determination mesh. For example, the game system 1 may set at most two types of materials as described above for the vertices to be used for generation of the display mesh, and may set one type of material for the vertices to be used for generation of the determination mesh. Then, the game system 1 may set two types of materials as materials of a polygon of the display mesh, and may set one type of material as a material of a polygon of the determination mesh, based on one type of material that is set for each vertex of this polygon. In setting one type of material for the vertices to be used for generation of the determination mesh, a material having the greatest determination value, among the determination values calculated for each material, may be set as materials of the vertices. Also in this case, as in the present example, the number of types of materials to be set for one polygon in the display mesh may be two at most, and the number of types of materials to be set for one polygon in the determination mesh may be one. Therefore, the information on materials set in the voxel data can be used for (e.g., reflected in) the display mesh, and the process to be performed according to the result of collision determination using the determination mesh is prevented from being complicated.

As described above, in the present example, a display mesh and a determination mesh are set for one voxel object. However, depending on the game situation, both the display mesh and the determination mesh may not necessarily be set for one voxel object at the same time (e.g., both the meshes may not necessarily be set in processing one frame). For example, in the game space, the determination mesh may be generated within a range where collision determination is performed, and may not necessarily be generated within a range where collision determination is not performed. As an example, the game system 1 may generate the determination mesh for voxel objects within a predetermined range around the player character. For voxel objects outside the predetermined range, the game system 1 may generate only the display mesh without generating the determination mesh.

As for the display mesh, the game system 1 may store data regarding the generated mesh in a memory. In frames after generation of the mesh, the game system 1 may use the stored data without executing the mesh generating process again, except for a range where an update is performed. This can decrease the processing load for generating the display mesh. Meanwhile, as for the determination mesh, the game system 1 may not necessarily store data regarding the generated mesh in the memory, and may generate a mesh on an as-needed basis (e.g., each time collision determination is required). This saves memory use for generation of the mesh.

The method for, when voxel data has been changed from its initial state, generating meshes (e.g., a display mesh and a determination mesh) based on the changed voxel data, has been described above. This method can also be used for a case where the meshes are generated based on the voxel data in the initial state when a game is started, for example. However, the meshes based on the voxel data in the initial state may not necessarily be generated based on the voxel data in the initial state when the game is started, and may be prepared in advance of starting the game.

In addition, in another example, only one of the display mesh and the determination mesh may be set (e.g., the display mesh and the determination mesh are the same mesh). In that case, the display mesh may also be used as the determination mesh, or the determination mesh may also be used as the display mesh. Thus, the same mesh may be shared as the display mesh and the determination mesh. In the case in which different meshes are used as the determination mesh and the display mesh, meshes suitable for respective applications can be used. In the case in which the same mesh is shared between rendering and collision determination, the processing load for setting a mesh can be reduced.

### [2-7. Player Character Return Movement Control Process]

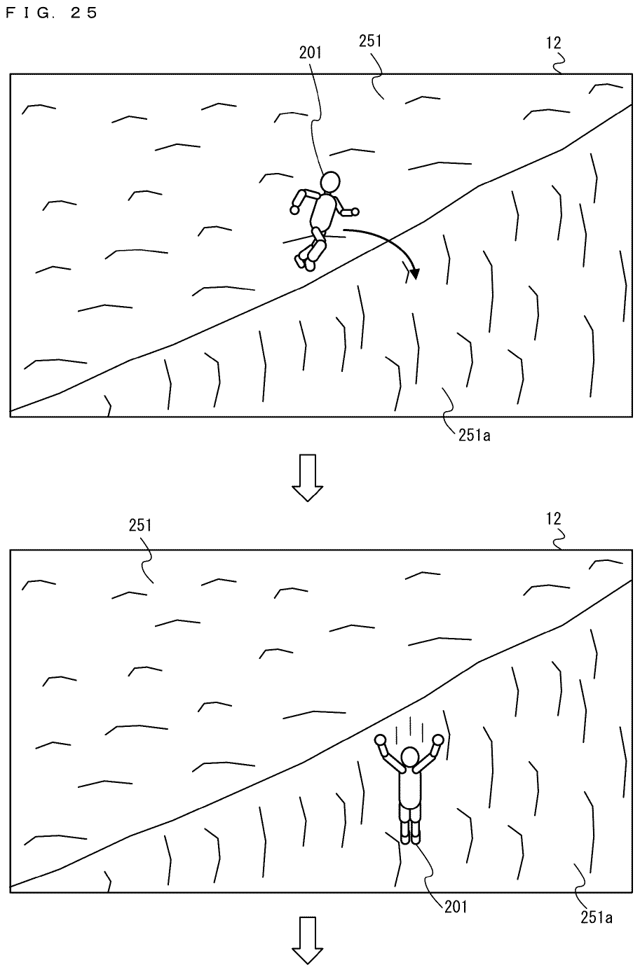

Next, an example process of executing player character return movement control will be described with reference to FIGS. 25 to 32. An example will be described below in which it is assumed that a terrain object such as a ground or wall is a voxel object, and an in-game behavior occurs as a result of performance of an action by a player character and collision determination.

The “in-game behavior” can include any change that occurs in the game. The in-game behavior is, for example, a change that occurs due to a “process of reflecting a result of contact between objects”. The “in-game behavior” may be any behavior as long as it is based on collision determination between the determination mesh and a determination shape corresponding to a determination target based on the game processing (e.g., a determination region set for an object such as the player character). The behavior may also occur in an object corresponding to the determination mesh. The content of the “in-game behavior” may be associated with a material set for a polygon on which a collision has been determined in collision determination that causes occurrence of the behavior (e.g., the content of the behavior may be determined based on the material).

FIGS. 25 to 27 are diagrams showing an example of game images representing a series of states in which a player character 201 moving on a terrain object enters an entrance-forbidden area in the game space and thereafter returns to a return position using a return item.

As shown in the upper diagram of FIG. 25, the game system 1 can perform movement control of the player character 201 at a position on a terrain and on a terrain object in the game space, based on the user's operation input. In the example shown in the upper diagram of FIG. 25, materials of polygons of a determination mesh of a terrain object 251 that is a ground are set to “rock”. The player character 201 is moving on a terrace surface of the terrain object 251 that is an example terrain. A cliff having a cliff wall surface (side surface) 251a is formed in the direction (movement direction) in which the player character 201 is moving.

In the upper diagram of FIG. 25, the game system 1 performs collision determination between the terrain object 251 and the player character 201 by using the determination mesh. That is, the game system 1 performs collision determination as to whether or not the determination mesh of the terrain object 251 comes into contact with a determination shape set for the player character (e.g., a region having a predetermined shape that is set based on the position of the player character). When a collision between the polygon whose material is rock and the player character 201 has been determined, the player character 201 is controlled such that the player character 201 is not allowed to enter the polygon, as a process of producing an in-game behavior. Therefore, the player character 201 can stand or walk on the polygons of the terrain object 251. It should be noted that in the present example, the player character 201 is allowed to change (e.g., deform) the terrain object 251, and therefore, for example, destroy and delete a portion of the terrain object 251.

The content of the process to be performed when a collision between the voxel object and the player character 201 has been determined, is discretionary. For example, the process may be a process of reducing the hit points of the player character 201 based on an impact when the collision has been determined, outputting the sound of footsteps of the player character 201, or displaying an effect (e.g., effect of representing dust or splash of water) on the contact part. In this case, the game system 1 can change the reduction in the hit points, the sound of footsteps, or the effect according to the type of the material set for the polygon, in the contact part, of the voxel object.

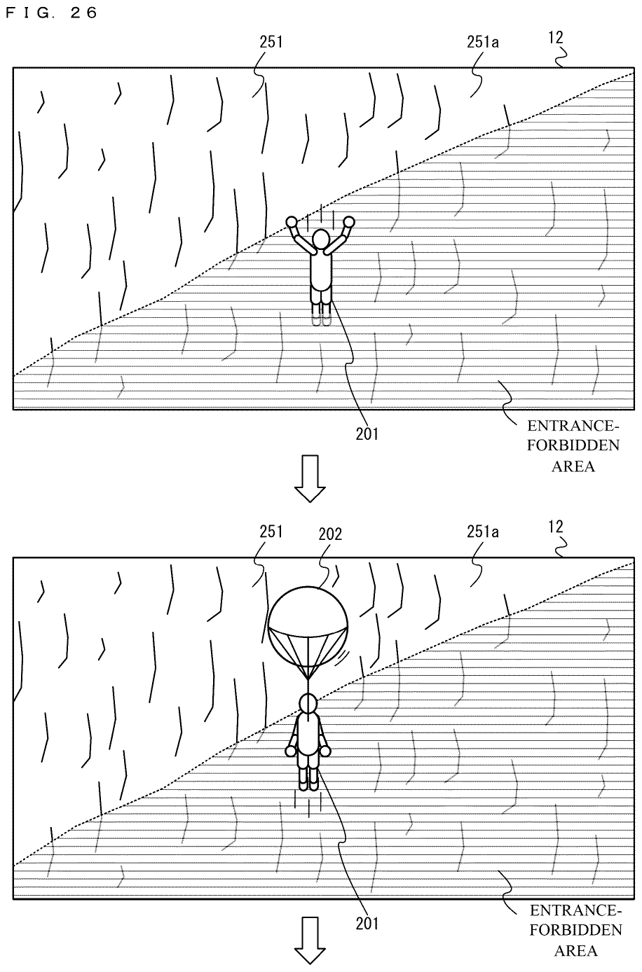

For example, when the player character 201 has fallen from the cliff shown in the lower diagram of FIG. 25, then if a collision is determined between the player character 201 and a ground formed below the cliff, a process of reducing the hit points of the player character 201 based on an impact depending on the difference in height between the terrace surface and the ground at the cliff bottom, a material of the ground, and the like is executed. In addition, as shown in the upper diagram of FIG. 26, if the cliff bottom is an entrance-forbidden area such as hell from which a player character cannot return, a process of ending the game, starting over the game, or the like is executed without the player character 201, which has entered the entrance-forbidden area, returning to the game space, no matter what difference in height there is between the terrace surface and the entrance-forbidden area.

In the present example, when the player character 201 stores at least a predetermined number of (e.g., one or more) return items that allow the player character 201 to return to the game space, the player character 201 can return to the game space and continue to play the game even if the player character 201 enters the entrance-forbidden area. A predetermined number of (e.g., one) return items are consumed for movement of the player character 201 for returning to the game space. Here, the return items may be temporarily stored by the player character 201 picking up the return items from the game space, or may be newly stored by the player character 201 when a predetermined event occurs. It should be noted that the state in which the player character 201 temporarily stores a return item refers to the state in which the player character 201 is allowed to carry the return item without wearing, holding, or the like the return item. At this time, the stored return items are not displayed in the game space. The stored return items can be taken out and then disposed in the game space or used (worn, held, etc.) by the player character 201 basically as appropriate. In the present example, the player character 201 stores a return item by putting the return item into a container attached to the body thereof (e.g., a pouch or item box). It should be noted that such a container may not be displayed. For such a container, only the function of storing return items may simply exist. In another embodiment, the return items may be possessed by the user who operates the player character 201 instead of the player character 201 storing the return items. Even when the user possesses the return items, the player character 201 operated by the user may be allowed to return.

As shown in the lower diagram of FIG. 26, when the player character 201 enters the range of the entrance-forbidden area while storing at least a predetermined number of return items, it is determined that a condition under which the player character 201 is allowed to move and return to a return position in the game space is satisfied. Thereafter, the movement control of the player character 201 based on the user's operation input is interrupted, and the player character 201 is allowed to escape from the entrance-forbidden area by consuming a predetermined number of return items 202. For example, the return items 202, which are virtual objects mimicking a balloon, bubbles, or the like, pull up the player character 201 and fly in the air in the game space, so that the player character 201 escapes from the entrance-forbidden area and moves. As an example, when a portion of the player character 201 comes into contact with the entrance-forbidden area, the game system 1 interrupts the movement control based on the user's operation input, causes a return item 202 to appear in the game space, and starts movement control for causing the player character 201 to return to a return position. It should be noted that if the player character 201 does not store at least a predetermined number of return items, then when the player character 201 falls into the entrance-forbidden area, a process of starting over, ending, or the like the game is executed without allowing the player character to return to the game space. As an example, when the player character 201 falls into the entrance-forbidden area, the player character 201 is caused to return to a previously set start point or predetermined checkpoint of the game while losing a predetermined amount of in-game currency, game items, or the like and the game is resumed, or the game is ended and the player character 201 is set back to the initial state in the game.

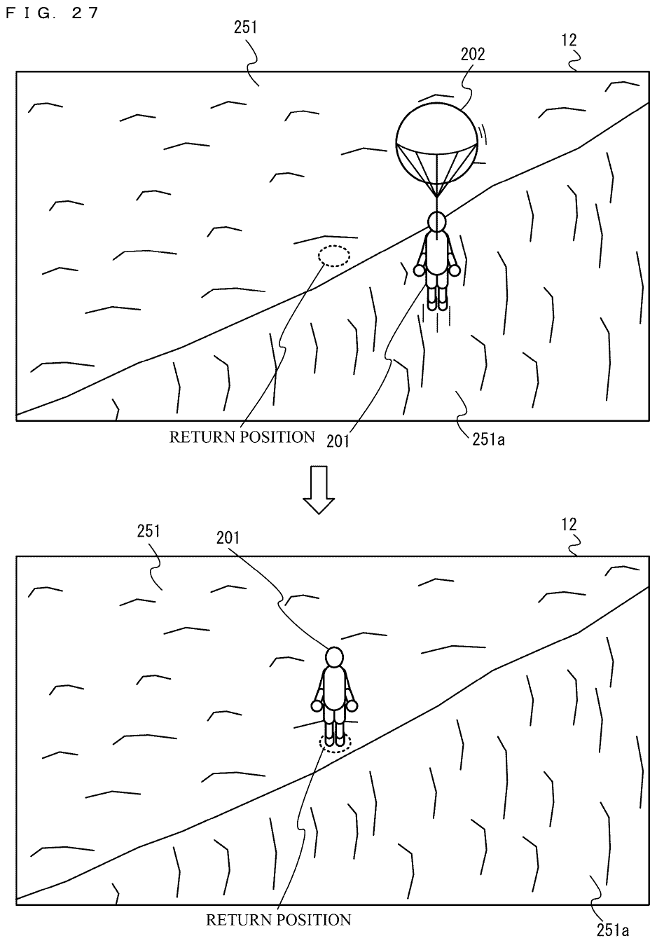

As shown in the upper and lower diagrams of FIG. 27, the game system 1 causes the player character 201 to move and return to a return position (described below) set in the game space, and resumes the movement control based on the user's operation input. For example, the return item 202 causes the player character 201 to move and return to a position where the player character 201 comes into contact with a ground that is a return position (see the upper diagram of FIG. 27). When the player character 201 comes into contact with the return position, the return item 202 is detached from the player character 201, and moves out of the display range of the game space or is deleted from the game space and is thereby consumed.

Thus, in the present example, when the player character 201 is located in the entrance-forbidden area of the game space, the movement control based on the user's operation input is interrupted, and the player character 201 is caused to move and return to the return position, and thereafter, the movement control based on the user's operation input is resumed. The movement to the return position is allowed under a condition that at least a predetermined number of return items that can be consumed for movement of the player character 201 for returning to the return position remain.

Next, an example in which the return position is set will be described. In the present example, in the case in which a plurality of candidate positions are sequentially set based on a state of the player character 201 in the game space or the like, then when a predetermined condition is satisfied by movement of the player character 201, the return position is determined from the plurality of candidate positions.

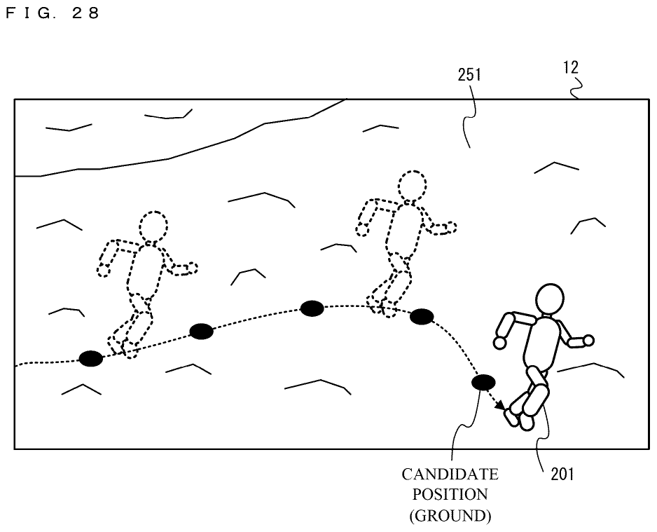

In the present example, a position where the player character 201 has immediately previously been in contact with a ground or wall is stored as a history, and candidate positions including a plurality of positions included in the history are set. For example, as shown in FIG. 28, when the player character 201 is on a terrain in the game space, a history of positions related to the movement of the player character 201 is stored. Here, the case in which the player character 201 is on a terrain means that a collision has been determined between the player character 201 and an upper surface of a determination mesh of a terrain object 251.

For example, the game system 1 performs collision determination between the player character 201 and a ground for past positions separated at regular intervals in the history of the movement on a terrain of the player character 201. Any past position on a ground where a collision has been determined and that is appropriate as a candidate position described below is stored. Here, the following and the like are excluded from positions on a ground that are appropriate as a candidate position, for example.
A position on a ground that move with progression of a game
A material of a determination mesh at a position on a ground, that is destroyed when damaged or coming into contact with another object
A position on a ground inappropriate as a return position such as a ground that is deleted when a predetermined condition is satisfied
A position for which a collision has been determined with a voxel object other than terrain objects such as a voxel object defined by a specific voxel space

Thereafter, the game system 1 stores and records, as candidate positions, past positions separated at regular intervals on a ground and appropriate as a candidate position. For example, the game system 1 sequentially records a past position separated by a predetermined distance from a candidate position previously recorded, as the next candidate position. The game system 1 repeats recording of a candidate position in the FIFO scheme so that a predetermined number of candidate positions existing in reverse chronological order from a candidate position most recently recorded are kept recorded. Thus, not all past positions on a ground through which the player character 201 has moved are necessarily recorded as a candidate position. Therefore, when the player character 201 moves on a ground, a position that is obtained each time the player character 201 moves over a predetermined distance and that is appropriate as a candidate position is recorded as a candidate position from a history of positions of the player character 201. It should be noted that in another example, the game system 1 may sequentially record a past position obtained when a predetermined period of time has passed since recording of the previously candidate position, as the next candidate position.

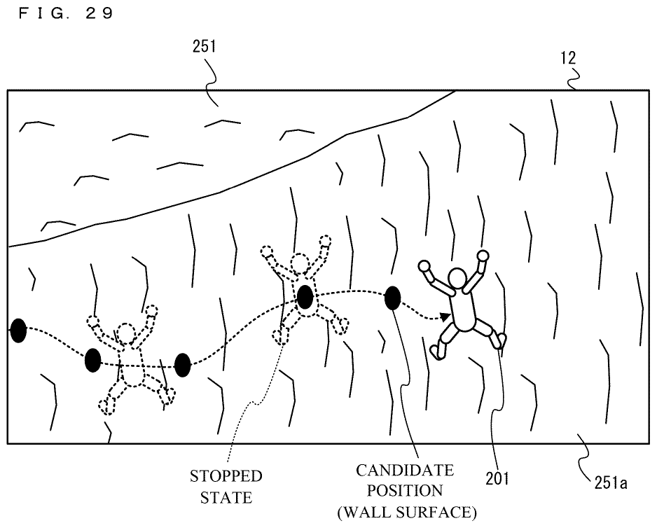

In addition, in the present example, a position where the player character 201 has immediately previously held a wall and thus has been in contact with the wall may also be stored as a history, and candidate positions including at least a plurality of positions included in the history may be set. For example, as shown in FIG. 29, when the player character 201 is in contact with a terrain that is a wall surface (side surface) 251a of a cliff in at least the forward direction, the player character 201 is controlled so as to be allowed to move at the position where the player character 201 is in contact with the terrain, based on the user's operation input. In addition, when the player character 201 is in contact with the terrain in the forward direction, the game system 1 stores a history of positions related to the movement along the terrain of the player character 201. Here, the case in which the player character 201 is in contact with a terrain in the forward direction means that a collision is determined between a side surface of a determination mesh of the terrain object 251 and the player character 201 with the player character 201 having a posture to face the side surface of the determination mesh.

For example, the game system 1 performs collision determination between the player character 201 and the wall surface for past positions separated at regular intervals that are included in a history of positions in the movement along the wall surface of the player character 201. If a past position on the wall surface for which a collision has been determined is appropriate as a candidate position, the past position is stored. Here, a position on a wall surface that is appropriate as a candidate position excludes those that satisfy at least one of the aforementioned conditions for a position on a ground that is inappropriate as a candidate position, and the following positions.
A material of a determination mesh that is inappropriate for holding (e.g., slippery materials) in a predetermined range including the position on the wall surface (e.g., a range in a predetermined distance in a downward direction of the position on the wall surface)

Thereafter, the game system 1 stores and records, as candidate positions, past positions separated at regular intervals on a wall surface and appropriate as a candidate position. For example, the game system 1 sequentially records a past position separated by a predetermined distance from a candidate position previously recorded, as the next candidate position. The game system 1 repeatedly performs recording of a candidate position in the FIFO scheme so that a predetermined number of candidate positions existing in reverse chronological order from a candidate position most recently recorded are kept recorded. Thus, not all past positions on a wall surface through which the player character 201 has moved are necessarily recorded as a candidate position. In addition, when the player character 201 has stopped for at least a predetermined period of time while holding a wall surface, the game system 1 excludes a candidate position immediately previously recorded from candidate positions, and sets and records (e.g., overwrites and records) the past position where the player character 201 has stopped as a new candidate position. As a result, for past positions in the movement along a wall surface of the player character 201, a position where the player character 201 has temporarily stopped while holding the wall surface can be reliably recorded as a candidate position. Therefore, when the player character 201 moves along a wall surface, a position that is obtained each time the player character 201 moves over a predetermined distance and that is appropriate as a candidate position is recorded as a candidate position from a history of positions of the player character 201, and an appropriate position on a wall surface (e.g., a position where the player character 201 has temporarily stopped while holding the wall surface) can be recorded as a candidate position.

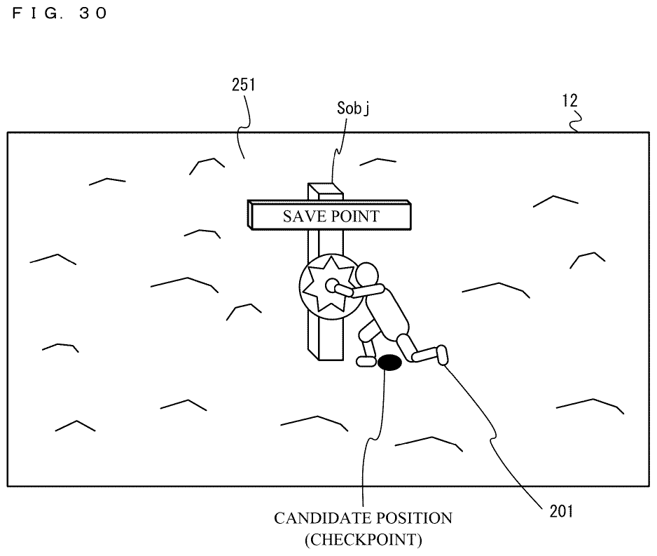

In addition, in the present example, a position related to a checkpoint in the game space may be set as a candidate position. For example, FIG. 30 shows an example in which a candidate position is set based on a motion that the player character 201 performs to use a save point that is an example of the checkpoint. For example, as shown in FIG. 30, the player character 201 performs a motion of touching a save object Sobj set at a predetermined position in the game space in order to use the save point. When the player character 201 performs a motion of touching the save object Sobj, the game system 1 sets and records a candidate position based on a predetermined position set for the position of the save object Sobj or the position where the player character 201 has performed the motion. Here, the save point is a point where game progression states that have occurred until the current time can be saved, and has the function of starting from the save point in the saved state upon the start of the next game. Therefore, when the player character 201 performs a motion of touching the save object Sobj, the game system 1 executes a process of saving game progression states that have occurred until the current time.

It should be noted that the checkpoint may be set at any position in the game space in addition to the save point. For example, in the case in which the player character 201 moves to a different layer in a game space having a seamless hierarchical structure, a position where the player character 201 reaches the different layer may be recorded as a checkpoint and a candidate position. The checkpoint may be a predetermined position that is previously set in a layer. Alternatively, the checkpoint may be a position where the player character 201 comes into contact with a terrain or another object for the first time when the player character 201 reaches the different layer.

In addition, in the present example, in addition to the checkpoint, a position based on a predetermined state of the player character 201 in the game space may be set as a candidate position. As an example, in the case in which the player character 201 is allowed to move by fast travel (e.g., warp or teleportation), a position of the destination of the fast travel may be recorded as a candidate position. In that case, the game system 1 may perform collision determination between the player character 201 and a ground or other objects immediately after the movement by fast travel, and record a position for which a collision has been determined as a candidate position. As another example, the first position immediately after the start of a new game stage may be recorded as a candidate position. In that case, the game system 1 may perform collision determination between the player character 201 and a ground or other objects immediately after the start of a game using a new game stage, and record a position for which a collision has been determined as a candidate position.

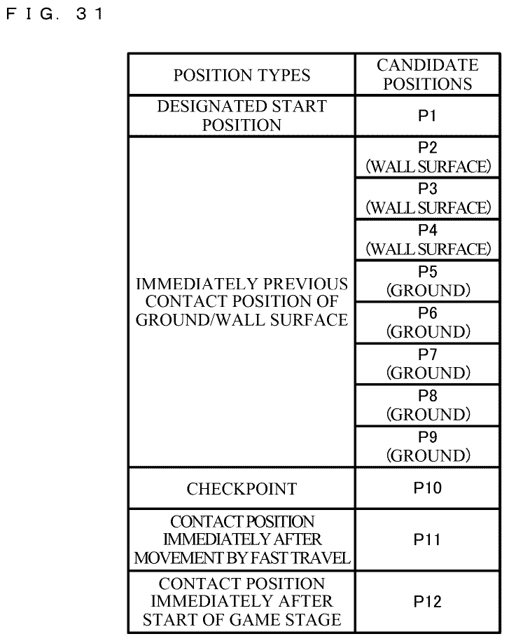

In the present example, the game system 1 sets a priority level for each of a plurality of candidate positions that have been recorded as described above, and determines a candidate position having a high priority level as a return position. For example, FIG. 31 shows an example in which a plurality of candidate positions recorded as described above are described in order of priority level with the highest first. Specifically, in FIG. 31, a plurality of candidate positions P2 to P9 are recorded as immediately previous contact positions with a ground or wall surface, and higher priority levels are set for candidate positions that have been recorded more recently in chronological order. Here, the candidate positions P2 to P4 where the player character 201 has immediately previously come into contact with a wall surface and the candidate positions P5 to P9 where the player character has immediately previously been on a ground, which are eight candidate positions, are recorded in order of priority level (the candidate position P2 has been most recently recorded and has a highest priority level of those of the candidate positions P2 to P9). In addition, in FIG. 31, a candidate position P10 related to a checkpoint is recorded. A candidate position related to a checkpoint has a priority level lower than that of a candidate position that is recorded as a position where the player character 201 has immediately previously come into contact with a ground or wall surface. In addition, in FIG. 31, a candidate position P11 related to a position that the player character 201 has come into contact with immediately after the movement by fast travel is recorded. A candidate position related to a contact position immediately after movement by fast travel has a priority level lower than that of a candidate position related to a checkpoint. Furthermore, in FIG. 31, a candidate position P12 related to a contact position immediately after the start of a game stage is recorded. A candidate position related to a contact position immediately after the start of a game stage has a priority level lower than that of a candidate position related to a contact position immediately after movement by fast travel.

Thus, in the present example, a plurality of candidate positions are recorded for which priority levels are set in descending order of a “candidate position related to an immediately previous contact position of a ground or wall surface”>a “candidate position related to a checkpoint”>a “candidate position related to a contact position immediately after movement by fast travel”>a “candidate position related to a contact position immediately after the start of a game stage”. It should be noted that in the present example, a candidate position having a priority level higher than that of a “candidate position related to an immediately previous contact position of a ground or wall surface” may be recorded, depending on the game stage in which the user is playing the game. For example, as shown in FIG. 31, in the case in which a game is played using an area in the game space where a designated start position is previously determined, the designated start position may be recorded as the candidate position P1, and after the end of the game, the candidate position P1 may be removed from candidates. As an example, when in a scene in which a game is played to aim to cause the player character 201 to clear a mini-game stage set in the game space, the position where the player character 201 starts the mini-game stage (e.g., a start point) or the positions through which the player character 201 has moved to a predetermined point in the mini-game stage (e.g., middle target points) are previously determined, the start point where the mini-game stage starts or the predetermined point is recorded as the candidate position P1. When the mini-game stage ends, the candidate position P1 recorded during play in the mini-game stage is removed from candidates.

In addition, in the present example, when a candidate position is newly recorded, the game system 1 may remove another candidate position from candidates. As a first example, when a candidate position related to a checkpoint is newly recorded, the game system 1 removes, from candidates, a more early recorded candidate position having a priority level higher than that of the newly recorded candidate position (e.g., a candidate position related to an immediately previous contact position of a ground or wall surface). As a second example, when a candidate position related to a contact position immediately after movement by fast travel is newly recorded, the game system 1 removes, from candidates, a more early recorded candidate position having a priority level higher than that of the newly recorded candidate position (e.g., a candidate position related to an immediately previous contact position of a ground or wall surface and a candidate position related to a checkpoint).

It should be noted that, of candidate positions recorded as a “candidate position related to an immediately previous contact position of a ground or wall surface”, a candidate position related to an immediately previous contact position on a ground and a candidate position related to an immediately previous contact position on a wall surface may be recorded as candidate positions having different priority levels. For example, a candidate position related to a contact position on a wall surface and a candidate position related to a contact position on a ground may be recorded such that the latter has a priority level higher than that of the former. In addition, the movement history of a player character moving on a wall surface may not be recorded as candidate positions, and only positions included in the movement history of a player character moving on a ground may be recorded as a “candidate position related to an immediately previous contact position of a ground or wall surface”.

In the present example, when the movement control for causing the player character 201 to return is started, candidate positions recorded at that time are sequentially subjected to determination of whether or not the position is suitable for return, in order of priority level with the highest first. A candidate position that is effective in causing the player character 201 to return is determined as a return position. For example, the game system 1 extracts a candidate position having a highest priority level of those recorded at that time, and unless a terrain is not present at the candidate position, determines that the candidate position is effective as a return position and determines the candidate position as a return position.

As an example, the game system 1 performs ray casting at the candidate position having a highest priority level. If a voxel object defined by voxel data having a density (e.g., a determination mesh of a terrain object) is present at the candidate position, it is determined that the candidate position is effective as a return position. For example, the ray casting in the vertical direction of the game space is performed in the direction toward the candidate position. If an object (e.g., a determination mesh of a terrain object) is hit at the candidate position, it is determined that the candidate position is effective as a return position (e.g., a terrain is present at the candidate position). Otherwise, i.e., if in the ray casting, an object (e.g., a determination mesh of a terrain object) is not hit at the candidate position, it is determined that the candidate position is ineffective as a return position (e.g., a terrain is not present at the candidate position). If it is determined that the candidate position is ineffective as a return position, ray casting is similarly performed at a candidate position having a second highest priority level. Likewise, ray casting is repeatedly performed until a candidate position that is effective as a return position is found. For example, ray casting is used when a candidate position is on a ground.

As another example, the game system 1 performs shape casting at a candidate position having a highest priority level, and determines that the candidate position is effective as a return position. For example, in the shape casting, a shape having the same shape as that of a determination region used in collision determination of the player character 201 is used, and it is determined whether or not a contact is present between the shape and a determination mesh at the candidate position. For example, the shape casting is used when a candidate position is on a wall surface. The determination is performed by moving the shape such that the center of the shape comes into contact with the candidate position from the outside of the wall surface in the horizontal direction toward the wall surface. If a voxel object defined by voxel data having a density (e.g., a determination mesh of a terrain object) is present at the candidate position where the shape casting is performed, and the wall surface at the candidate position has a shape that can be held by the player character 201, the game system 1 determines that the candidate position is effective as a return position. Although the shape used in the shape casting is the same as the shape of the determination region used in the collision determination of the player character 201 in order to facilitate the shape casting, the shape may be a capsule shape, or spherical, ellipsoidal, polyhedral (e.g., a bounding box), cylindrical, conical, or pyramidal, or the shape of the polygon of the player character 201. In addition, the shape may be a flat surface, curved surface, circle, straight line, line segment, point, or the like.

Thus, in the present example, of a plurality of candidate positions recorded at that time, a return position is determined from candidate positions that are not a position where a terrain is not present. Here, a terrain object for which a candidate position is recorded includes a voxel object, and therefore, a determination mesh of the terrain object (terrain mesh) is likely to be deformed after the candidate position is recorded. Therefore, a terrain for which a candidate position is recorded may not be present at the time when a return position is determined. However, in the present example, of a plurality of candidate positions previously recorded at the time when a return position is determined, a return position is determined from candidate positions that are not a position where a terrain is not present. Therefore, a candidate position that is not a position where a terrain is not present can be selected from a plurality of candidate positions without causing the player character 201 to return to a position where a terrain is no longer present. Thus, the player character 201 can be caused to return to an appropriate return position.

In addition, in the present example, of a plurality of candidate positions recorded at that time, a return position is determined from candidate positions having a high priority level. In addition, when a candidate position is newly recorded, the game system 1 may remove another candidate position having a high priority level from candidates. As a result, even in the case in which a return position is determined in a game using a game space having a seamlessly continuous hierarchical structure, the player character 201 can be prevented from moving to a different layer when moving and returning to the return position. For example, as described above, when the player character 201 reaches a different layer to come into contact with a terrain or other objects for the first time at a position, and the position is recorded as a checkpoint and a candidate position, a previously recorded candidate position related to a checkpoint is removed from candidates, and one having a priority level higher than that of the candidate position is removed from candidates. In addition, when a position that is a destination of fast travel performed by the player character 201 is recorded as a candidate position, a previously recorded candidate position related to a contact position immediately after movement by fast travel is removed from candidates, and one having a priority level higher than that of the candidate position is removed from candidates. Therefore, when the player character 201 moves in the game space from a first layer to a second layer that is different from the first layer, a recorded candidate position in first layer is removed from candidates, and therefore, when the player character 201 moves and returns in the same second layer, return movement is performed in which a return position determined in the same second layer is a destination.

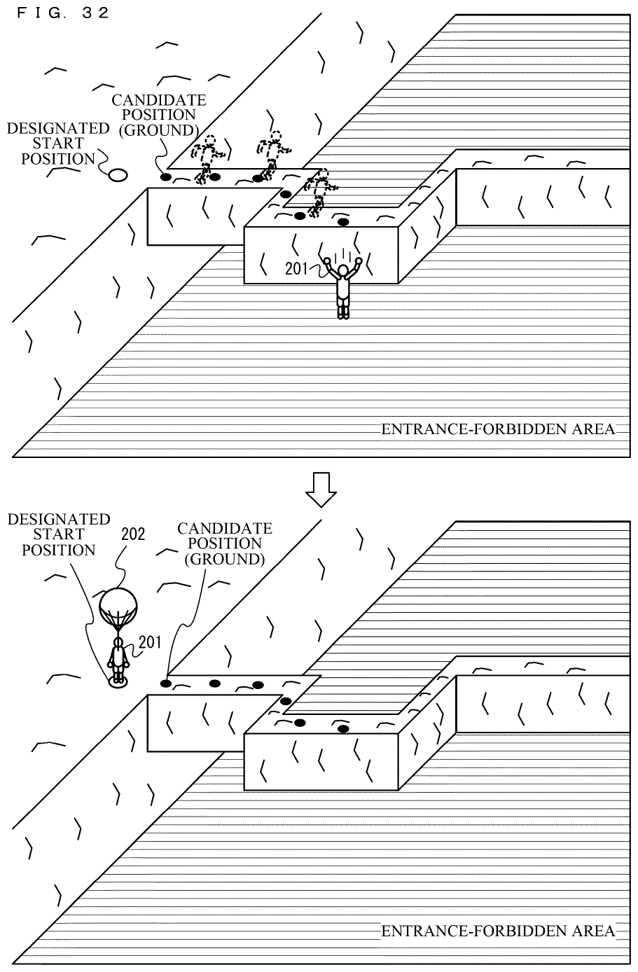

In addition, in the present example, a candidate position having a highest priority level may be recorded, depending on a game stage in which the user is playing the game. For example, as shown in the upper diagram of FIG. 32, when the player character 201 is disposed in an area in which a mini-game stage is constructed in which the player character 201 moves on a single path from which the player character 201 enters an entrance-forbidden area if the player character 201 falls therefrom, without falling from the single path, a designated start position is previously set as a start point of the mini-game. In that case, the game system 1 records the designated start position as a candidate position having a highest priority during a period of time when the player character 201 is disposed in the area. When the player character 201 starts moving from the start position (designated start position), the game system 1 records a candidate position related to a contact position of a ground at regular intervals. When due to the movement, the player character 201 falls from the single path, then if the player character 201 has at least a predetermined number of return items, movement control is performed to cause the player character 201 to return to a return position.

At this time, as shown in the lower diagram of FIG. 32, a candidate position having a highest priority level serves as the designated start position. Therefore, the game system 1 determines the designated start position as a return position instead of the immediately previously recorded candidate positions related to contact positions of a ground and separated at regular intervals, and performs movement control for causing the player character 201 to return to the designated start position. For example, in a game space in which a mini-game stage that the player character 201 aims to clear is constructed, when the player character 201 is caused to return to the candidate position that the player character 201 has immediately previously been in contact with as a return position, the player character 201 may be stuck in the mini-game stage, so that the player character 201 may not move. In the present example, by causing the player character 201 to move and return to the preset start point, middle target point, or the like of the mini-game stage, the mini-game stage can be prevented from failing to be cleared.

It should be noted that in the process of determining whether or not a candidate position is effective as a return position, ray casting or shape casting is used. Any one of ray casting and shape casting may be used, depending on the type of a terrain for which candidate positions are recorded. For example, in determination of a candidate position on a ground, shape casting, both of ray casting and shape casting, or other methods may be used. In addition, in determination of a candidate position on a wall surface, ray casting, both of ray casting and shape casting, or other methods may be used.

In addition, the recorded candidate position or determined return position may include, in addition to information indicating a position in the game space, and information indicating a direction and posture of a player character. For example, information indicating a direction (e.g., the front direction or vertical direction) or posture of a player character in the game space as it is when a candidate position is recorded, may be recorded as a candidate position together with information indicating a position in the game space. In addition, when a player character returns to a return position, the player character may return to the game space based on information indicating a direction and posture of the player character included in the candidate position that has been used in determination of the return position.

In addition, the recorded candidate position or determined return position may be a position on a terrain object in the game space, e.g., any position in the game space, except for positions on a determination mesh defined by voxels constituting a terrain object. As a first example, the candidate position and return position may be set to a position on another object that is a voxel object and is different from the terrain object. As a second example, the candidate position and return position may be set on a movable object (e.g., a movable terrain object) in the game space. As a third example, the candidate position and return position may be set to a position on a virtual object other than voxel objects or a position on a game field. As a fourth example, the candidate position and return position may be set on a water surface or in the air in the game space (e.g., a start point set in the air or a position where a player character is hanging down on a predetermined object).

Although in the present example, a player character is allowed to return to a return position if the player character has at least a predetermined number of return items, the condition under which a player character is allowed to return to a return position is not particularly limited. As a first example, the condition under which a player character is allowed to return to a return position may be that the player character has a plurality of types of return items. As a second example, the condition under which a player character is allowed to return to a return position may be set based on the game mode. For example, if a game mode is set in which the difficulty of a game is relatively low, a player character may be allowed to return to a return position, and if a game mode is set in which the difficulty of a game is relatively high, a player character may be forbidden to return to a return position. As a third example, the condition under which a player character is allowed to return to a return position may be set based on the level of a player character or the game proficiency of the user. For example, if the level of a player character or the game proficiency of the user is relatively low, the player character may be allowed to return to a return position, and if the level of a player character or the game proficiency of the user has reached a predetermined level or proficiency, the player character may be forbidden to return to a return position.

Although in the present example, when the player character 201 has moved into the range of an entrance-forbidden area, it is determined that the condition under which the player character 201 returns to a return position in the game space is satisfied, the state in which the condition is satisfied is not particularly limited. As an example, when the player character 201 has moved and deviated from a range in the game space in which game play is permitted, it is determined that the condition under which the player character 201 returns to a return position in the game space is satisfied. As another example, when the player character 201 has been stuck, so that the player character 201 cannot leave the position or region by movement, it is determined that the condition under which the player character 201 returns to a return position, and that allows the player character 201 to be freed from the stuck state, is satisfied.

### [3. Specific Example of Processing in Game System]

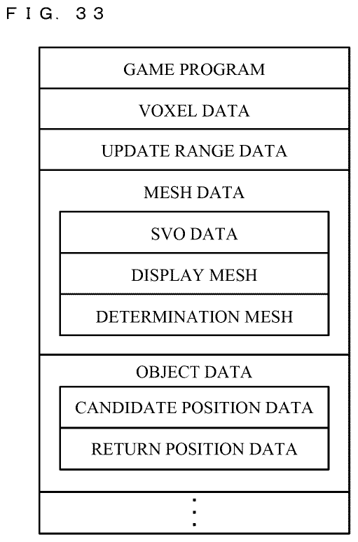

Next, a specific example of information processing in the game system 1 will be described with reference to FIGS. 33 to 38.

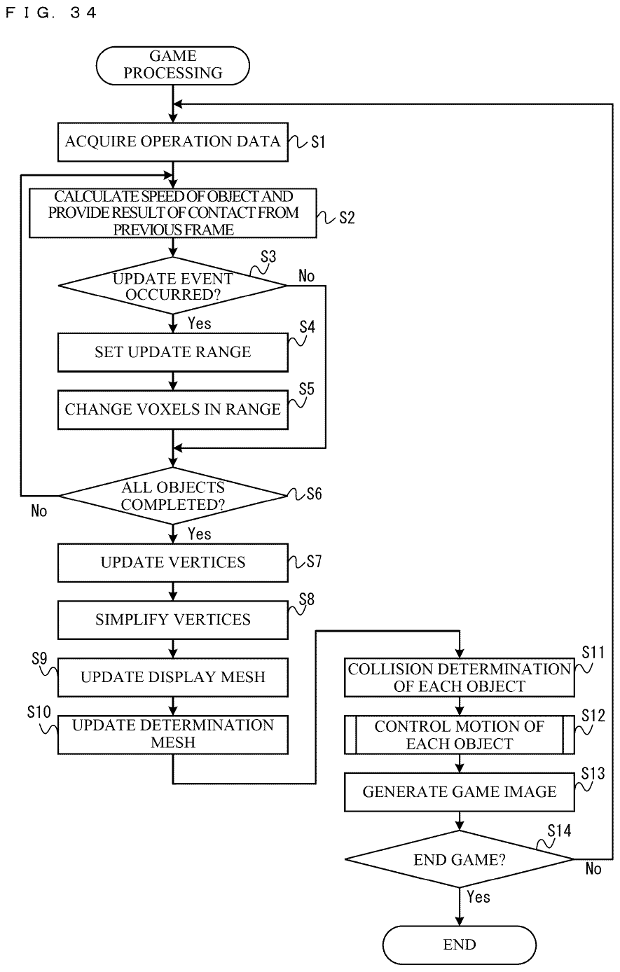

FIG. 33 shows an example of various data used for information processing in the game system 1. The data shown in FIG. 33 are stored in a memory (e.g., the flash memory 84, the DRAM 85, and/or a memory card attached to the slot 23) that is accessible by the main body apparatus 2. As shown in FIG. 33, the game system 1 stores a game program therein. The game program is a program for executing game processing (e.g., game processing shown in FIGS. 34 to 38) in the present example. The game program includes the aforementioned material data (see FIG. 12). In the memory, the aforementioned voxel data (see FIG. 11), update range data, mesh data, object data, and the like (see FIG. 33).

The update range data is data indicating the aforementioned update range. In the present example, the update range is represented by the aforementioned SDF.

The mesh data includes various data regarding meshes of a voxel object. As shown in FIG. 30, in the present example, the mesh data includes SVO data, display mesh data, and determination mesh data. The SVO data is data in which vertices calculated from the voxel data are held by the aforementioned SVO structure. In the present example, the SVO data includes data indicating materials set for the vertices (e.g., data indicating IDs of the materials) in addition to data indicating the positions of the vertices. The display mesh data includes various data regarding a display mesh. Specifically, the display mesh data includes data indicating vertices of the display mesh, and data indicating materials set for the vertices (e.g., data indicating IDs of the materials). The determination mesh data includes various data regarding a determination mesh. Specifically, the determination mesh data includes data indicating vertices of the determination mesh, and data indicating materials set for the vertices (data indicating IDs of the materials).

The object data includes various data regarding objects (e.g., a player character and a virtual object) other than the voxel object. The object data is stored for each object that appears in the game space. The object data includes data indicating, for example, the position, speed, state, etc., of the object. In addition, the object data includes candidate position data and return position data. In the candidate position data, a plurality of recorded candidate positions are described in order of priority level. The return position data indicates determined return positions.

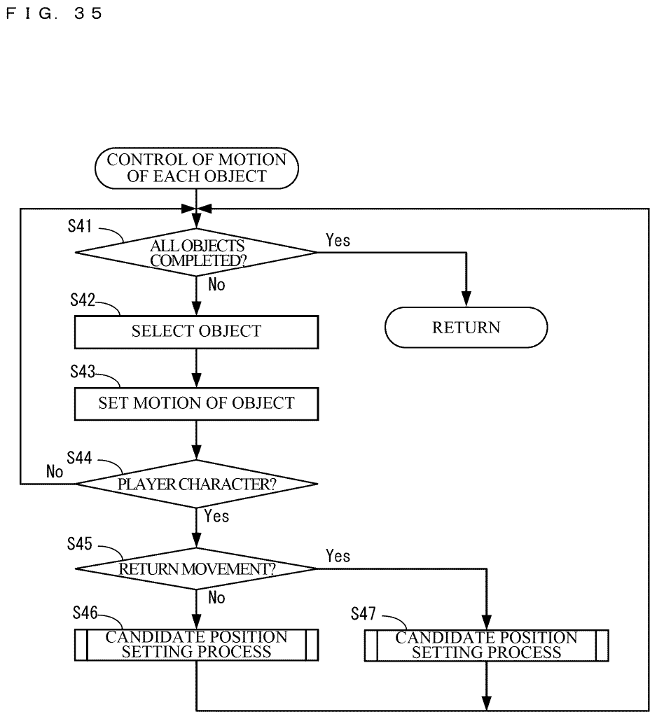

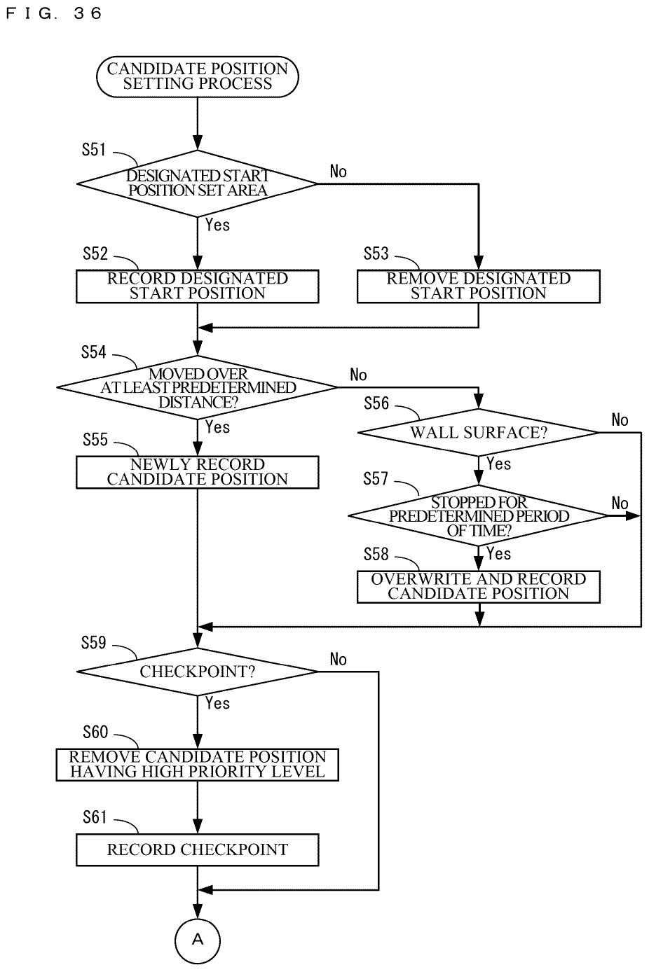

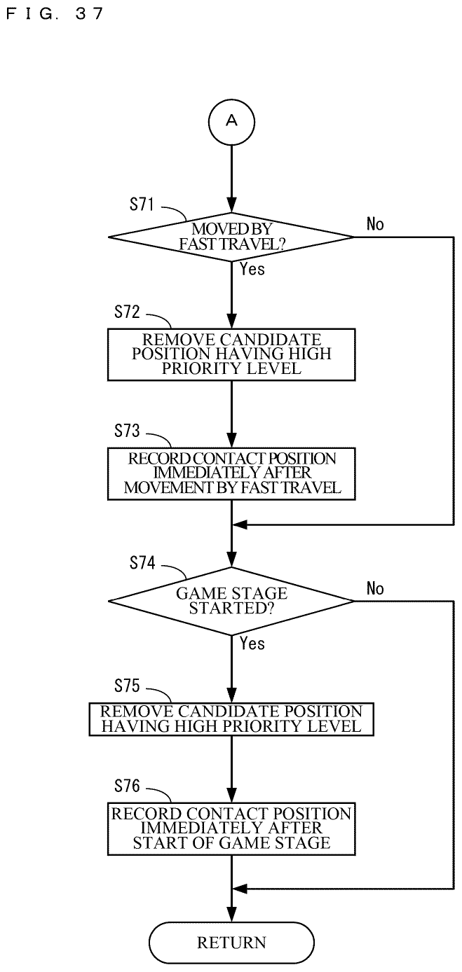

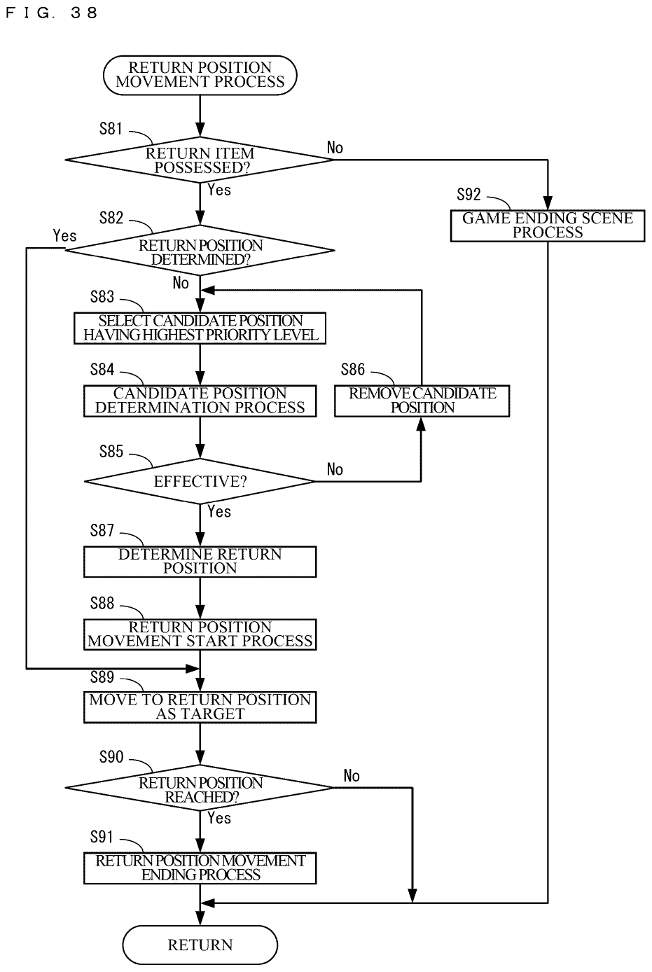

FIG. 34 is a flowchart showing an example of a flow of game processing executed by the game system 1. FIG. 35 is a subroutine showing an example of a process of controlling a motion of each object in step S12 of FIG. 34. FIG. 36 is a subroutine showing an example of a first half of a candidate position setting process in step S46 of FIG. 35. FIG. 37 is a subroutine showing an example of a second half of the candidate position setting process in step S46 of FIG. 35. FIG. 38 is a subroutine showing an example of a return position movement process in step S47 of FIG. 35. Execution of the game processing is started in response to the game having been started according to an instruction of the player, during execution of the game program, for example. A processing loop composed of a series of processes in steps S1 to S14 is performed in a cycle of once for each frame.

In the present example, the processor 81 of the main body apparatus 2 executes the game program stored in the game system 1 to execute processes in steps shown in FIGS. 34 to 38. However, in other examples, a portion of the processes in the steps may be executed by a processor (e.g., a dedicated circuit or the like) other than the processor 81. Further, if the game system 1 is communicable with another information processing apparatus (e.g., a server), a portion of the processes in the steps shown in FIGS. 34 to 38 may be executed by the other information processing apparatus. The processes in the steps shown in FIGS. 34 to 38 are merely examples, and the processing order of the steps may be changed, or another process may be executed in addition to (or instead of) the processes in the steps as long as similar results can be obtained.

The processor 81 executes the processes in the steps shown in FIGS. 34 to 38 by using a memory (e.g., the DRAM 85). That is, the processor 81 stores information (in other words, data) obtained in each process step, into the memory, and reads out the information from the memory when using the information for the subsequent process steps.

In FIG. 34, the processor 81 obtains operation data indicating the user's operation input (step S1), and proceeds to the next step. For example, the processor 81 acquires the operation data output from the respective controllers via the controller communication section 83 and/or the terminals 17 and 21 or the operation data output from the main body apparatus 2 (e.g., the touch panel 13).

Next, the processor 81 designates, as a processing target, an object for which processing has not yet been completed (including a voxel object defined in the specific voxel space) among objects to be processed in the game space, and executes, for the designated object, a process of calculating a speed, and a process of providing (e.g., reflecting) a result of contact between objects in a previous frame (step S2), and proceeds to the next step. The speed of the object is used for calculating the position of the object in the current frame, in the process of step S12 described below. For example, if the designated object is a player character, the speed of the player character is calculated based on the operation data acquired in step S1. If the designated object is an object that is not operated by the user, the speed of the object is calculated based on a rule prescribed in the game program. As an example, the speed of the object is calculated based on a virtual physical calculation including interaction between objects. For example, repulsion due to a collision between objects, interaction such as friction due to contact, falling due to virtual gravity, deceleration due to virtual air resistance, or the like is provided in determination of the speed.

The process of providing the result of contact between objects in the previous frame includes a process of, upon determining in the collision determination (step S11 described below) that objects have come into contact with each other, giving an influence due to the contact, to the objects. Examples of this process are as follows.
A process of, when in the previous frame it is determined that a player character has come into contact with a terrain object due to falling, so that an impact has been applied to a player character, reducing the hit points of the player character
A process of, when it is determined that a player character has come into contact with a terrain object by performing the punching action or the like in the previous frame, generating a fragment object

If the state regarding an object has been changed in the process in step S2, the processor 81 updates the corresponding object data stored in the memory regarding the object such that the object data indicates the changed content.

Next, the processor 81 determines whether or not an update event that updates the voxel object has been caused by the object designated in step S2 (step S3). For example, the determination in step S3 is performed based on the result of collision determination (step S11 described below) in the previous frame. As an example, when it is determined that a player character has come into contact with a terrain object by performing the punching action or the like in the previous frame, it is determined that an update event in which a portion of the terrain object is deleted has occurred. If the update event has occurred, the processor 81 proceeds to step S4. If the update event has not occurred, the processor 81 proceeds to step S6.

In step S4, the processor 81 sets, in the game space, an update range in which update of the voxel object is performed, and proceeds to the next step. For example, the specific content (e.g., position, shape, and size) of the update range is associated with each of the types of update events in the game program. In step S4, the update range is set so as to have the content associated with the type of the update event that has been determined in step S3 to occur. In step S4, the processor 81 stores data indicating the set update range, as update range data in the memory.

Next, the processor 81 changes the voxels corresponding to the update range set in step S4, according to the update event (step S5), and proceeds to step S6. For example, in performing deformation such that a voxel object within the update range is deleted or downsized or a voxel object is added within the update range, the processor 81 updates the voxel data stored in the memory so as to change the densities of the voxels corresponding to the update range (see the above [2-2. Update of voxel data]).

In step S6, the processor 81 determines whether or not all objects that need to be processed (including a voxel object defined by a specific voxel space) have been completely processed in steps S2 to S5. If all of the objects have been completely processed, the processor 81 proceeds to step S7. Otherwise, i.e., if not all of the objects have been completely processed, the processor 81 returns to and repeats step S2.

In step S7, the processor 81 updates the vertices of the voxel object in the game space, and proceeds to the next step. For example, if the voxel data has been updated in the process in step S5, the processor 81 calculates new vertices based on the updated voxel data. The positions of the new vertices are calculated according to the method described in the above [2-3. Calculation of vertices]. In addition, materials of the new vertices are calculated according to the method described in the above [2-4. Determination of material of vertex].

Next, the processor 81 performs simplification for the vertices (step S8), and proceeds to the next step. For example, the processor 81 performs simplification for the vertices updated in the process in step S7, according to the method described in the above [2-5. Simplification of vertices]. Thereafter, the processor 81 updates the SVO data stored in the memory is updated so as to indicate the vertices obtained through the processes in steps S7 and S8. The processes in steps S7 and S8 may not necessarily calculate new vertices for the entirety of the voxel data, and may be performed only for the part in which the content of the voxels has been changed in the process in step S5.

Next, the processor 81 updates the display mesh of the voxel object, based on the SVO data stored in the memory (step S9), and proceeds to the next step. The positions of the vertices of the display mesh and the materials of the polygons in the display mesh (e.g., the materials set for the vertices of the polygons) are calculated according to the method described in the above [2-6. Generation of mesh] and [2-6-1. Determination of material of display mesh]. In step S9, the processor 81 updates the display mesh data stored in the memory so as to indicate the positions and materials of the vertices of the updated display mesh. The processor 81 may start the process in step S10 and subsequent steps described below without waiting for completion of step S9 to execute these steps in parallel with step S9. In that case, step S9 needs to be completed before start of step S13 described below.

Next, the processor 81 updates the determination mesh of the voxel object, based on the SVO data stored in the memory (step S10), and proceeds to the next step. The positions of the vertices of the determination mesh and the materials of the polygons in the determination mesh (e.g., the materials set for the vertices of the polygons) are calculated according to the method described in the above [2-6. Generation of mesh] and [2-6-2. Determination of material of determination mesh]. In step S10, the processor 81 updates the determination mesh data stored in the memory so as to indicate the positions and materials of the vertices of the updated determination mesh.

In the example shown in FIG. 31, the determination mesh generation process in step S10 is executed for each frame, but the determination mesh generation process may not necessarily be executed for each frame. For example, in the case where the collision determination process in step S11 described below is executed only for a frame that satisfies a predetermined condition, the processor 81 may execute the determination mesh generation process in the frame in which the collision determination is performed. In addition, the processor 81 may execute the determination mesh generation process for voxels in a region, in the game space, where the collision determination in step S11 is performed. For example, in a situation where, in the game space, an object to be subjected to collision determination does not exist around the player character, except for a voxel object (e.g., a situation where only collision determination between the player character and the neighboring voxel object needs to be performed), the processor 81 may execute the determination mesh generation process for voxels within a predetermined range based on the player character.

Next, the processor 81 performs collision determination for each object in the game space, based on the determination mesh data and the object data stored in the memory (step S11), and proceeds to the next step. For example, the processor 81 performs collision determination by using a determination mesh for a voxel object, and using, for an object that is not a voxel object, a determination region having a predetermined shape, which is set for the object. In the present example, the collision determination in step S11 is performed in consideration of the speed calculated in step S2. That is, the processor 81 performs collision determination by using, as the position of each object, the position to which the object moves at the speed.

In the present example, presence/absence of the following contacts is determined by the collision determination in step S11.
Contact of the player character with the terrain object when the player character performs the punching action or the like
Contact of a player character with a terrain object due to movement such as falling

If the result of the collision determination in step S11 is that the objects have come into contact with each other, a process of determining (e.g., generating) the result of the contact of the objects is performed in step S2 in the next frame, or it is determined in step S3 in the next frame that an update event has occurred.

Next, the processor 81 controls the motion of each object in the game space (step S12), and proceeds to step S13. A process of controlling a motion of each object that is executed in step S12 will be described below with reference to FIG. 35.

In FIG. 35, the processor 81 determines whether or not the control process has been completed on all objects to be subjected to the motion control (step S41). If there is one of the objects on which the control process has not been completed, the processor 81 proceeds to step S42. Otherwise, i.e., if the control process has been completed on all of the objects, the processor 81 ends the subroutine.

In step S42, the processor 81 selects an object to be subjected to the motion control from objects on which the motion control has not been complete, and proceeds to the next step.

Next, the processor 81 controls a motion of the object that has been currently selected as an object to be subjected to the motion control (step S43), and proceeds to the next step. For example, as for the player character, the processor 81 performs a control that causes the player character to move or perform various actions, based on the operation data acquired in step S1. Thereafter, if a predetermined action has occurred, the processor 81 generates a determination region for collision determination according to the action in the game space. In addition, the processor 81 performs control to cause the object released by the player character's throwing action to move in the direction in which the object has been released. It should be noted that in a single process in step S43, as for a motion (e.g., an action of the player character) that is performed over a plurality of frames, the processor 81 controls each object so as to progress the motion for one frame. As a result, by the process in step S43 being repeatedly executed over a plurality of frames, each object performs a series of motions regarding movement and various actions. In addition, in step S43, if movement or motions of a player character that is performed over a plurality of frames is newly set, the player character performs the newly set movement or motions by repeated execution of step S43 over a plurality of frames. The position of each object is basically determined to be the position after the object has moved with the speed calculated in step S2. However, in the case where an object is determined to come into contact with another object by the collision determination in step S11 and movement of this object is prevented by the other object, the position of the object may be determined not to be changed. In step S43, the processor 81 updates the object data stored in the memory so as to have the content indicating the object after the control in step S43.

Next, the processor 81 determines whether or not the object that has been currently selected as an object to be subjected to the motion control is a player character (step S44). If the object that has been currently selected as an object to be subjected to the motion control is a player character, the processor 81 proceeds to step S45. Otherwise, i.e., if the object that has been currently selected as an object to be subjected to the motion control is not a player character, the processor 81 returns to and repeats step S41.

In step S45, the processor 81 determines whether or not to cause the player character to move to the return position. For example, if in step S43, the player character's motion of moving to the return position (e.g., a motion of entering the entrance-forbidden area (see the upper diagram of FIG. 28)) is set, or if a process of causing the player character to move to the return position, which is described below, is continued, the result of the determination by the processor 81 in step S45 is positive. If the player character is not to be caused to move to the return position, the processor 81 proceeds to step S46. Otherwise, i.e., if the player character is to be caused to move to the return position, the processor 81 proceeds to step S47.

In step S46, the processor 81 executes a candidate position setting process, and returns to and repeats step S41. An example of the candidate position setting process of step S46 will be described with reference to FIG. 36 and FIG. 37.

In FIG. 36, the processor 81 determines whether or not the player character is playing a game that uses an area for which a designated start position has been previously determined (step S51). If the player character is playing the game that uses the area, the processor 81 proceeds to step S52. Otherwise, i.e., if the player character is not playing the game that uses the area, the processor 81 proceeds to step S53.

In step S52, the processor 81 records, as a candidate position, the designated start position set in the area used in the game that the player character is playing, and proceeds to step S54. For example, the process of recording a designated start position as a candidate position is executed in accordance with the method described with reference to FIG. 31 in [2-7. Player character return movement control process], and the designated start position is recorded as a candidate position having a highest priority level. Thereafter, in step S52, the processor 81 updates the candidate position data stored in the memory so that the candidate position data includes the content after the recording in step S52.

In step S53, the processor 81 removes the designated start position recorded as a candidate position from candidates, and proceeds to step S54. For example, if the designated start position is recorded as a candidate position in the candidate position data stored in the memory, the processor 81 removes the candidate position from candidates, and updates the candidate position data so that the candidate position data includes the content after the removal.

In step S54, the processor 81 determines whether or not the player character has moved over at least a predetermined distance from the most recent candidate position recorded in the “candidate positions related to an immediately previous contact position of a ground or wall surface” in the candidate position data. If the player character has moved over at least the predetermined distance from the most recent recorded candidate position, the processor 81 proceeds to step S55. Otherwise, i.e., if the player character has not moved over at least the predetermined distance from the most recent recorded candidate position, the processor 81 proceeds to step S56.

In step S55, the processor 81 newly records, as a candidate position, the position on a ground or wall surface on which the player character is disposed, and proceeds to step S59. For example, the process of recording, as a candidate position, a position on a ground or wall surface on which the player character is disposed is executed in the method described with reference to FIGS. 28, 29, and 31 in [2-7. Player character return movement control process], and the position on a ground or wall surface on which the player character is disposed is recorded as a candidate position having a highest priority level of those of the “candidate positions related to an immediately previous contact position of a ground or wall surface”. Thereafter, in step S55, the processor 81 updates the candidate position data stored in the memory so that the candidate position data includes the content after the recording in step S55.

Meanwhile, in step S56, the processor 81 determines whether or not the player character is disposed on a wall surface in the game space. If the player character is disposed on a wall surface, the processor 81 proceeds to step S57. Otherwise, i.e., if the player character is not disposed on a wall surface, the processor 81 proceeds to step S59.

In step S57, the processor 81 determines whether or not the period of time for which the player character has stopped moving on the wall surface has reached a predetermined period of time. If the period of time for which the player character has stopped moving has reached the predetermined period of time, the processor 81 proceeds to step S58. Otherwise, i.e., if the period of time for which the player character has stopped moving has not reached the predetermined period of time, the processor 81 proceeds to step S59.

In step S58, the processor 81 newly overwrites and records, as a candidate position, the position on the wall surface where the player character has stopped moving, and proceeds to step S59. For example, the process of overwriting and recording, as a candidate position, a position where the player character has stopped moving on a wall surface for at least a predetermined period of time is executed in accordance with the method described with reference to FIGS. 29 and 31 in [2-7. Player character return movement control process], and the position on the wall surface where the player character has stopped moving is overwritten and recorded instead of the candidate position most recently recorded in the “candidate positions related to an immediately previous contact position of a ground or wall surface”. Thereafter, in step S58, the processor 81 updates the candidate position data stored in the memory so that the candidate position data includes the content after the overwriting and recording in step S58.

In step S59, the processor 81 determines whether or not the player character has performed a motion related to a checkpoint (see FIG. 30) or has reached a predetermined checkpoint. If the player character has performed the motion related to a checkpoint or has reached the predetermined checkpoint, the processor 81 proceeds to step S60. Otherwise, i.e., if the player character has not performed the motion related to a checkpoint or has not reached the predetermined checkpoint, the processor 81 proceeds to step S71 (see FIG. 37).

In step S60, the processor 81 removes a candidate position having a priority level higher than that of a candidate position related to a checkpoint and recorded in the candidate position data (e.g., a candidate position related to an immediately previous contact position of a ground or wall surface) from candidates, and proceeds to the next step. For example, the process of removing a candidate position from candidates is executed in accordance with the method described with reference to FIG. 31 in [2-7. Player character return movement control process]. Thereafter, in step S60, the processor 81 updates the candidate position data stored in the memory so that the candidate position data includes the content after the removal in step S60.

Next, the processor 81 newly records, as a candidate position, the position related to a checkpoint where the player character is disposed (step S61), and proceeds to step S71 (see FIG. 37). For example, the process of recording a candidate position related to a checkpoint is executed in accordance with the method described with reference to FIGS. 30 and 31 in [2-7. Player character return movement control process], and a new candidate position is recorded instead of the “candidate position related to a checkpoint” previously recorded in the candidate position data. Thereafter, in step S61, the processor 81 updates the candidate position data stored in the memory so that the candidate position data includes the content after the recording in step S61.

Referring to FIG. 37, in step S71, the processor 81 determines whether or not the player character has performed a motion of moving by fast travel. If the player character has performed a motion of moving by fast travel, the processor 81 proceeds to step S72. Otherwise, i.e., if the player character has not performed a motion of moving by fast travel, the processor 81 proceeds to step S74.

In step S72, the processor 81 removes a candidate position having a priority level higher than that of a candidate position related to a contact position immediately after movement by fast travel and recorded in the candidate position data (e.g., a candidate position related to an immediately previous contact position of a ground or wall surface, or a candidate position related to a checkpoint) from candidates, and proceeds to the next step. For example, the process of removing a candidate position from candidates is executed in accordance with the method described with reference to FIG. 31 in [2-7. Player character return movement control process]. Thereafter, in step S72, the processor 81 updates the candidate position data stored in the memory so that the candidate position data includes the content after the removal in step S72.

Next, the processor 81 newly records, as a candidate position, the position where the player character is disposed immediately after movement by fast travel (step S73), and proceeds to step S74. For example, the process of recording a candidate position related to a contact position immediately after movement by fast travel is executed in accordance with the method described with reference to FIG. 31 in [2-7. Player character return movement control process], and a new candidate position is recorded instead of the “candidate position related to a contact position immediately after movement by fast travel” previously recorded in the candidate position data. Thereafter, in step S73, the processor 81 updates the candidate position data stored in the memory so that the candidate position data includes the content after the recording in step S73.

In step S74, the processor 81 determines whether or not the user has started the game using a new game stage. If the game using a new game stage has been started, the processor 81 proceeds to step S75. Otherwise, i.e., if the game using a new game stage has not been started, the processor 81 ends the subroutine.

In step S75, the processor 81 removes a candidate position having a priority level higher than that of a candidate position related to a contact position immediately after the start of a game stage and recorded in the candidate position data (e.g., a candidate position related to an immediately previous contact position of a ground or wall surface, a candidate position related to a checkpoint, or a candidate position related to a contact position immediately after movement by fast travel) from candidates, and proceeds to the next step. For example, the process of removing a candidate position from candidates is executed in accordance with the method described with reference to FIG. 31 in [2-7. Player character return movement control process]. Thereafter, in step S75, the processor 81 updates the candidate position data stored in the memory so that the candidate position data includes the content after the removal in step S75.

Next, the processor 81 newly records, as a candidate position, a contact position immediately after the start of a game stage where the player character is disposed (step S76), and ends the subroutine. For example, the process of recording a candidate position related to a contact position immediately after the start of a game stage is executed in accordance with the method described with reference to FIG. 31 in [2-7. Player character return movement control process], and a new candidate position is recorded instead of the “candidate position related to a contact position immediately after the start of a game stage” previously recorded in the candidate position data. Thereafter, in step S76, the processor 81 updates the candidate position data stored in the memory so that the candidate position data includes the content after the recording in step S76.

Referring back to FIG. 35, if in step S45 it is determined that the player character is to be caused to move to the return position, the processor 81 executes a return position movement process (step S47), and returns to and repeats step S41. An example of the return position movement process executed in step S47 will be described below with reference to FIG. 38.

In FIG. 38, the processor 81 determines whether or not the player character possesses (e.g., stores) a return item or is currently using a return item (step S81). If the player character possesses a return item or is currently using a return item, the processor 81 proceeds to step S82. Otherwise, i.e., if the player character does not possess a return item or is not currently using a return item, the processor 81 proceeds to step S92.

In step S82, the processor 81 looks up in the return position data stored in the memory to determine whether or not a return position has previously been determined. If a return position has not been determined, the processor 81 proceeds to step S83. Otherwise, i.e., if a return position has already been determined, the processor 81 proceeds to step S89.

In step S83, the processor 81 selects a candidate position having a highest priority level indicated by the candidate position data stored in the memory, and proceeds to the next step.

Next, the processor 81 executes a determination process on the candidate position selected in step S83 (step S84), and proceeds to the next step. For example, the processor 81 determines whether or the selected candidate position is effective as a return position, in accordance with the method described in [2-7. Player character return movement control process].

Next, based on the result of the determination process of step S84, the processor 81 determines whether or not the candidate position selected in step S83 is effective as a return position (step S85). If the selected candidate position is not effective as a return position, the processor 81 proceeds to step S86. Otherwise, i.e., if the selected candidate position is effective as a return position, the processor 81 proceeds to step S87.

In step S86, the processor 81 removes, from the candidate position data, the candidate position that it has been determined is not effective in the determination process of step S84, and returns to and repeats step S83.

Meanwhile, in step S87, the processor 81 determines, as a return position, the candidate position that it has been determined is effective in the determination process of step S84, and proceeds to the next step. For example, the processor 81 updates the return position data stored in the memory using the candidate position determined as a return position.

Next, the processor 81 executes a return position movement start process (step S88), and proceeds to step S89. For example, the processor 81 causes the player character to stop the movement motion and wear a return item, and sets a motion of causing the player character to move toward the return position determined in step S87. Thereafter, in step S88, the processor 81 updates the object data stored in the memory so that the object data includes the content indicating the player character after the control in step S88.

In step S89, the processor 81 executes a process of causing the player character to move to the return position, and proceeds to the next step. Thereafter, in step S89, the processor 81 updates the object data stored in the memory so that the object data indicates the content indicating the player character after the control in step S89. It should be noted that by repeatedly executing step S89 over a plurality of frames, the player character is caused to perform a motion of moving to the return position determined in step S87 (see the lower diagram of FIG. 26 and the upper diagram of FIG. 27).

Next, the processor 81 determines whether or not the player character has reached the return position (step S90). If the player character has reached the return position, the processor 81 proceeds to step S91. Otherwise, i.e., if the player character has not reached the return position, the processor 81 ends the subroutine.

In step S91, the processor 81 executes a return position movement ending process, and ends the subroutine. For example, the processor 81 places the player character at the return position indicated by the return position data. In addition, the processor 81 removes the worn return item from the player character and causes the player character to move out of the display range of the game space or deletes the player character from the game space (see the lower diagram of FIG. 27), and subtracts the number of return items that have been used from the number of return items possessed (stored) by the player character. Thereafter, in step S91, the processor 81 updates the object data stored in the memory so that the object data includes the content indicating the player character after the control in step S91.

In step S81, if it is determined that the player character has not possessed or used a return item, the processor 81 executes a game ending scene process (step S92), and ends the subroutine. For example, the processor 81 starts a scene in which the player character enters an entrance-forbidden area, so that the game is ended. Thereafter, in step S92, the processor 81 updates the object data stored in the memory so that the object data includes the content indicating the player character after the control in step S92. The process of step S92 is executed until the scene is ended by repeated execution thereof over a plurality of frames. When the scene is ended, the return position movement process of step S47 is ended.

Referring back to FIG. 34, after executing the process of controlling a motion of each object in step S12, the processor 81 generates a game image (step S13), and proceeds to the next step. For example, the processor 81 generates a game image by performing rendering, based on the virtual camera, for the polygons of the display mesh of the voxel object, and the polygons of objects other than the voxel object. The polygons of the display mesh are rendered by using rendering setting such as textures corresponding to materials set for the polygons, according to the method described in the above [2-6-1. Determination of material of display mesh]. The game image generated in step S13 is outputted to the display device and displayed in a cycle of once for each frame.

Next, the processor 81 determines whether or not to end the game (step S14). For example, if a predetermined operation input to end the game has been performed by the user or if a condition for ending the game is satisfied, the determination result in step S14 is positive. If the processor 81 determines to end the game, the processor 81 ends the flowchart. If the processor 81 does not determine to end the game, the processor returns to and repeats step S1. Thereafter, a series of processes in steps S1 to S14 is repeatedly executed until the processor 81 determines to end the game in step S14.

Thus, in the present example, in a game space in which a generated determination mesh of a terrain object (terrain mesh) is likely to be deformed based on updating of voxels, the return position of the player character can be appropriately set so that the player character is not caused to return to a position where a terrain object is no longer present.

Although in the foregoing description, an example has been described in which a voxel object is specified by generating a three-dimensional mesh based on voxel data set for voxels in a three-dimensional space, a voxel object may be specified based on voxel data set for two-dimensional voxels.

It should be noted that the information processing apparatus 1 may be any suitable apparatus, including handheld game apparatuses, personal digital assistants (PDAs), mobile telephones, smartphones, personal computers, cameras, tablet computers, and the like. In that case, an input apparatus for performing a user operation of moving a player character or the like may not be the left controller 3, the right controller 4, the touch panel 13, or the like, and may be other controllers, a mouse, a touch pad, a touch panel, a trackball, a keyboard, a directional pad, a slide pad, or the like.

In the foregoing, each information process (game process) is performed in the game system 1 by way of example. Alternatively, at least a portion of the process steps may be performed in another apparatus. For example, when the information processing apparatus 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the information processing apparatus 1 executing predetermined programs. Alternatively, all or a portion of the above processes may be performed by a dedicated circuit included in the information processing apparatus 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the information processing apparatus 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

Thus, the present example is useful as a game program, game system, game processing method, game apparatus, and the like that are, for example, capable of appropriately setting a return position for a player character in a game in which a generated mesh is likely to be deformed based on updating of voxels.

What is claimed is:

1. One or more non-transitory computer-readable storage media having stored therein instructions that, when executed, cause an information processing system to perform operations comprising:
updating voxel data defined in a virtual space and indicating a terrain, based on game processing, wherein in the voxel data, for each of a plurality of voxels, at least a density indicating the degree of virtual occupation of a content in a space defined by the voxel is set;
updating a terrain mesh related to the voxel data and indicating the terrain, wherein vertex coordinates of the terrain mesh are determined based on at least the density included in the voxel data; and
in the game processing,
in a first case in which a player character is on at least the terrain, performing movement control of the player character at a position on the terrain based on an operation input, and storing the position of the player character as a history, and
when a first condition is satisfied due to movement of the player character,
interrupting the movement control based on the operation input,
determining a return position from candidates including a plurality of positions included in the history, except for a position where the terrain is not present, and
causing the player character to move and return to the return position, and resuming the movement control based on the operation input.

2. The one or more non-transitory computer-readable storage media according to claim 1, wherein
the operations further comprise, in the game processing:
causing the player character to perform a first action based on an operation input;
setting a first voxel update range in the virtual space based on the first action; and
reducing the densities of voxels of the voxel data related to the first voxel update range.

3. The one or more non-transitory computer-readable storage media according to claim 1, wherein
the operations further comprise, in the game processing:
in a second case in which the player character is in contact with the terrain in at least a forward direction, controlling the player character so as to allow the player character to move at a position where the player character is in contact with the terrain, based on an operation input, and storing the position of the player character as the history.

4. The one or more non-transitory computer-readable storage media according to claim 3, wherein
the operations further comprise:
in the second case, storing a position where the player character is located each time the player character moves over a distance, and a position where the player character stops, as at least the history.

5. The one or more non-transitory computer-readable storage media according to claim 1, wherein
the operations further comprise, in the game processing:
when the player character reaches a checkpoint in the virtual space, storing the checkpoint as the candidate, and removing the history previously stored from the candidates.

6. The one or more non-transitory computer-readable storage media according to claim 3, wherein
the operations further comprise, in the game processing:
determining a most recent one of the candidates as the return position.

7. The one or more non-transitory computer-readable storage media according to claim 1, wherein
the first condition includes a condition that the position of the player character is in a first range in the virtual space.

8. The one or more non-transitory computer-readable storage media according to claim 7, wherein
the first condition further includes a condition that a first possessed item that is consumed due to the return movement of the player character remains.

9. The one or more non-transitory computer-readable storage media according to claim 1, wherein
in the voxel data, a material indicating the type of the content is set for each of the plurality of voxels, and
the operations further comprise:
generating or updating a display mesh related to the voxel data and to be rendered based on a virtual camera, by determining vertex coordinates of the display mesh based on at least the density included in the voxel data and determining a material of the display mesh based on at least the material included in the voxel data; and
rendering the virtual space including the display mesh based on the vertex coordinates of the display mesh and a texture related to the material of the display mesh.

10. The one or more non-transitory computer-readable storage media according to claim 1, wherein
in the voxel data, a material indicating the type of the content is set for each of the plurality of voxels, and
the operations further comprise:
determining a material of the terrain mesh based on at least the material included in the voxel data; and
rendering the virtual space including the terrain mesh as a display mesh based on vertex coordinates of the display mesh and a texture related to the material of the display mesh.

11. A game system comprising:
one or more processors; and
one or more memories storing instructions to perform operations comprising:
updating voxel data defined in a virtual space and indicating a terrain, based on game processing, wherein in the voxel data, for each of a plurality of voxels, at least a density indicating the degree of virtual occupation of a content in a space defined by the voxel is set;
updating a terrain mesh related to the voxel data and indicating the terrain, wherein vertex coordinates of the terrain mesh are determined based on at least the density included in the voxel data; and
in the game processing,
in a first case in which a player character is on at least the terrain, performing movement control of the player character at a position on the terrain based on an operation input, and storing the position of the player character as a history, and
when a first condition is satisfied due to movement of the player character,
interrupting the movement control based on the operation input,
determining a return position from candidates including a plurality of positions included in the history, except for a position where the terrain is not present, and
causing the player character to move and return to the return position, and resuming the movement control based on the operation input.

12. The game system according to claim 11, wherein
the operations further comprise, in the game processing:
causing the player character to perform a first action based on an operation input;
setting a first voxel update range in the virtual space based on the first action; and
reducing the densities of voxels of the voxel data related to the first voxel update range.

13. The game system according to claim 11, wherein
the operations further comprise, in the game processing:
in a second case in which the player character is in contact with the terrain in at least a forward direction, controlling the player character so as to allow the player character to move at a position where the player character is in contact with the terrain, based on an operation input, and storing the position of the player character as the history.

14. The game system according to claim 13, wherein
the operations further comprise:
in the second case, storing a position where the player character is located each time the player character moves over a distance, and a position where the player character stops, as at least the history.

15. The game system according to claim 11, wherein
the operations further comprise, in the game processing:
when the player character reaches a checkpoint in the virtual space, storing the checkpoint as the candidate, and removing the history previously stored from the candidates.

16. The game system according to claim 13, wherein
the operations further comprise, in the game processing:
determining a most recent one of the candidates as the return position.

17. The game system according to claim 11, wherein
the first condition includes a condition that the position of the player character is in a first range in the virtual space.

18. The game system according to claim 17, wherein
the first condition further includes a condition that a first possessed item that is consumed due to the return movement of the player character remains.

19. The game system according to claim 11, wherein
in the voxel data, a material indicating the type of the content is set for each of the plurality of voxels, and
the operations further comprise:
generating or updating a display mesh related to the voxel data and to be rendered based on a virtual camera, by determining vertex coordinates of the display mesh based on at least the density included in the voxel data and determining a material of the display mesh based on at least the material included in the voxel data; and
rendering the virtual space including the display mesh based on the vertex coordinates of the display mesh and a texture related to the material of the display mesh.

20. The game system according to claim 11, wherein
in the voxel data, a material indicating the type of the content is set for each of the plurality of voxels, and
the operations further comprise:
determining a material of the terrain mesh based on at least the material included in the voxel data; and
rendering the virtual space including the terrain mesh as a display mesh based on vertex coordinates of the display mesh and a texture related to the material of the display mesh.

21. A game processing method, comprising:
updating voxel data defined in a virtual space and indicating a terrain, based on game processing, wherein in the voxel data, for each of a plurality of voxels, at least a density indicating the degree of virtual occupation of a content in a space defined by the voxel is set;
updating a terrain mesh related to the voxel data and indicating the terrain, wherein vertex coordinates of the terrain mesh are determined based on at least the density included in the voxel data; and
in the game processing,
in a first case in which a player character is on at least the terrain, performing movement control of the player character at a position on the terrain based on an operation input, and storing the position of the player character as a history, and
when a first condition is satisfied due to movement of the player character,
interrupting the movement control based on the operation input,
determining a return position from candidates including a plurality of positions included in the history, except for a position where the terrain is not present, and
causing the player character to move and return to the return position, and resuming the movement control based on the operation input.

22. The game processing method according to claim 21, further comprising, in the game processing:
causing the player character to perform a first action based on an operation input;
setting a first voxel update range in the virtual space based on the first action; and
reducing the densities of voxels of the voxel data related to the first voxel update range.

23. The game processing method according to claim 21, further comprising, in the game processing:
in a second case in which the player character is in contact with the terrain in at least a forward direction, controlling the player character so as to allow the player character to move at a position where the player character is in contact with the terrain, based on an operation input, and storing the position of the player character as the history.

24. The game processing method according to claim 23, further comprising:
in the second case, storing a position where the player character is located each time the player character moves over a distance, and a position where the player character stops, as at least the history.

25. The game processing method according to claim 21, further comprising, in the game processing:
when the player character reaches a checkpoint in the virtual space, storing the checkpoint as the candidate, and removing the history previously stored from the candidates.

26. The game processing method according to claim 23, further comprising, in the game processing:
determining a most recent one of the candidates as the return position.

27. The game processing method according to claim 21, wherein
the first condition includes a condition that the position of the player character is in a first range in the virtual space.

28. The game processing method according to claim 27, wherein
the first condition further includes a condition that a first possessed item that is consumed due to the return movement of the player character remains.

29. The game processing method according to claim 21, wherein
in the voxel data, a material indicating the type of the content is set for each of the plurality of voxels, and
the method further comprises:
generating or updating a display mesh related to the voxel data and to be rendered based on a virtual camera, by determining vertex coordinates of the display mesh based on at least the density included in the voxel data and determining a material of the display mesh based on at least the material included in the voxel data; and
rendering the virtual space including the display mesh based on the vertex coordinates of the display mesh and a texture related to the material of the display mesh.

30. The game processing method according to claim 21, wherein
in the voxel data, a material indicating the type of the content is set for each of the plurality of voxels, and
the method further comprises:
determining a material of the terrain mesh based on at least the material included in the voxel data; and
rendering the virtual space including the terrain mesh as a display mesh based on vertex coordinates of the display mesh and a texture related to the material of the display mesh.
